(19) United States
(12) Patent Application Publication
(10) Pub. No.: US 2026/0023468 A1
(43) Pub. Date: Jan. 22, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventors: KOUTA MURASAWA, Kanagawa (JP); TAKAYUKI YAMADA, Kanagawa (JP); KAZUYA OGASAWARA, Kanagawa (JP); FUMINO MATSUI, Kanagawa (JP); SHINJIRO HORI, Kanagawa (JP)

(21) Appl. No.: 19/267,397

(22) Filed: Jul. 11, 2025

(30) Foreign Application Priority Data
Jul. 19, 2024 (JP) 2024-115757

(51) Int. Cl. G06F 3/04845; G06F 3/04847

(52) U.S. Cl. CPC G06F 3/04845; G06F 3/04847

(57) ABSTRACT

An information processing apparatus includes one or more processors and/or circuitry which function as: a designation unit configured to designate a design element to be reflected in one or more commercial materials for which to generate designs, and designate a creation condition for creating the one or more commercial materials; and a generation unit configured to, based on the design element and the creation condition designated by the designation unit, generate designs of the one or more commercial materials by changing a color scheme included in the design element such that at least one color at a hue angle different from any of colors in the color scheme in the design element.

### BACKGROUND

### Field of the Technology

The present disclosure relates to an information processing apparatus, and a method of controlling an information processing apparatus, and a storage medium.

### Description of the Related Art

There has been proposed a method which involves preparing in advance templates each containing information such as the shapes and layout of an image, characters, a graphic, and the like that form a poster, and automatically arranging an image, characters, a graphic, and the like according to such a template to generate a poster. Japanese Patent Laid-Open No. 2017-059123 discloses a technique which involves selecting templates in ascending order of the difference between an impression evaluation value of the template and an impression evaluation value of an image, and generating posters with the templates. It is required to generate appropriate cohesive designs that represent an impression intended by the user by combining plural commercial materials.

### SUMMARY

An information processing apparatus according to the present disclosure, includes one or more processors and/or circuitry which function as: a designation unit configured to designate a design element to be reflected in one or more commercial materials for which to generate designs, and designate a creation condition for creating the one or more commercial materials; and a generation unit configured to, based on the design element and the creation condition designated by the designation unit, generate designs of the one or more commercial materials by changing a color scheme included in the design element such that at least one color at a hue angle different from any of colors in the color scheme in the design element.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a commercial material generation apparatus;

FIG. 2 is a software block diagram of a commercial material creation application;

FIGS. 3A and 3B are diagrams describing a skeleton;

FIG. 4 is a diagram describing a color scheme pattern;

FIG. 5 is a diagram showing the relationship of FIGS. 5A and 5B, and FIGS. 5A and 5B are diagrams illustrating a display screen provided by the commercial material creation application;

FIGS. 6A, 6B, 6C, 6D, 6E, and 6F are diagrams illustrating a display screen provided by the commercial material creation application;

FIG. 7 is a flowchart illustrating a poster generation process representing a process of quantifying impressions of posters;

FIG. 8 is a diagram describing a subjective evaluation of a poster;

FIGS. 9A, 9B, and 9C are flowcharts illustrating a commercial material generation process;

FIGS. 10A, 10B, 10C, and 10D are diagrams describing a color scheme list;

FIGS. 11A, 11B, and 11C are diagrams describing a color scheme pattern obtaining unit;

FIG. 12 is a diagram describing a subjective evaluation of a color scheme pattern;

FIGS. 13A, 13B, and 13C are diagrams describing a method of selecting skeletons;

FIGS. 14A and 14B are diagrams describing a method of selecting color scheme patterns and fonts;

FIG. 15 is a software block diagram describing a layout unit in detail;

FIG. 16 is a flowchart illustrating a layout process;

FIGS. 17A, 17B, and 17C are diagrams describing inputs into the layout unit;

FIGS. 18A, 18B, 18C, and 18D are diagrams describing an operation of the layout unit;

FIG. 19 is a diagram showing the relationship of FIGS. 19A and 19B, and FIGS. 19A and 19B are diagrams illustrating a display screen provided by the commercial material creation application;

FIG. 20 is a software block diagram of a commercial material creation application;

FIG. 21 is a flowchart illustrating a commercial material generation process;

FIGS. 22A, 22B, 22C, 22D, and 22E are diagrams describing a combination generation unit; and

FIGS. 23A and 23B are diagrams describing the combination generation unit.

### DESCRIPTION OF THE EMBODIMENTS

Hereinafter, with reference to the attached drawings, the present disclosure is explained in detail in accordance with embodiments. The present disclosure is not limited to configurations shown in the following embodiments. In addition, the same components are denoted by the same reference numerals. Further, each process (step) in the flowcharts and the sequence charts is denoted by a reference numeral starting with S.

In the following embodiments, a “commercial material” refers to a printed product, such as a poster, a brochure, a store's menu, or a postcard, and is, for example, the design of an advertising medium for users.

In the embodiments, a “brand” is a company's or store's identity (such as its corporate philosophy, vision, code of conduct, or characteristics) expressed through design. To make a brand widely recognized by users, it is necessary to convey messages to users through designs that have a consistent worldview. What is important in building brand awareness is cohesive designs with a consistent worldview. To achieve this, it is necessary to ensure that product packaging, store designs, and commercial materials for promotion (including websites, brochures, posters, business cards, and postcards), which are means for contacting users, have cohesive designs. In order for plural commercial materials to have cohesive designs, they need to include similar design elements. Examples of the design elements include logos, fonts, patterns, colors, and so on. Including such design elements in plural commercial materials provides cohesive designs, allowing users to recognize a consistent worldview. Further, a brand can be represented by combining plural commercial materials. For example, even in a case where a brochure and a poster are created with different background colors, combining the brochure and the poster can produce a design that represents a brand. Representing a brand by combining plural commercial materials broadens the range of expression, allowing for creation of seasonal designs and development of design series.

The following embodiments will each describe an example of automatically generating designs which represent a brand's cohesive impression intended by a user with a combination of commercial materials. This enables a user without knowledge in design to generate plural commercial materials for building brand awareness.

### First Embodiment

A first embodiment will exemplarily describe a method by which a commercial material generation apparatus automatically generates plural commercial materials by causing an application (hereinafter referred to also as “app”) for creating commercial materials to operate. It is to be noted that, in the following description, the term “image” includes a still image captured by a camera, a frame image extracted from a moving image, and an illustration created by a paint tool or the like, unless otherwise noted.

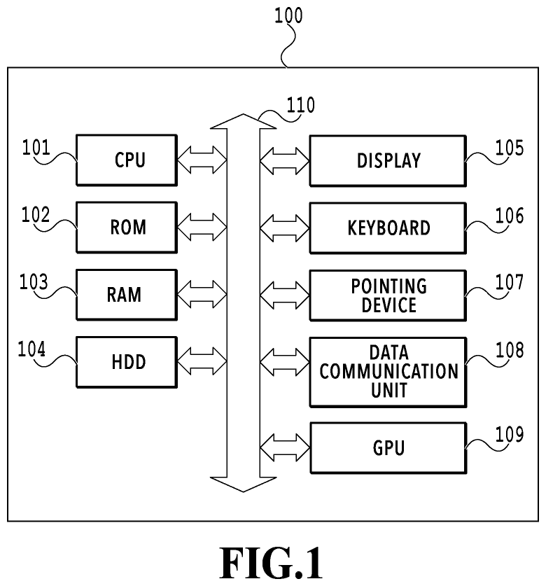

FIG. 1 is a block diagram illustrating a hardware configuration of a commercial material generation apparatus 100. Note that the commercial material generation apparatus 100 is an information processing apparatus, and examples thereof include a personal computer (hereinafter referred to as “PC”), a tablet terminal, a smartphone, and so on. The present embodiment will be described on the assumption that the commercial material generation apparatus is a PC. The commercial material generation apparatus 100 is a central processing unit (CPU) 101, a read-only memory (ROM) 102, a random-access memory (RAM) 103, a hard disk drive (HDD) 104, a display 105, a keyboard 106, a pointing device 107, a data communication unit 108, and a graphics processing unit (GPU) 109.

The CPU 101 comprehensively controls the commercial material generation apparatus 100 and, for example, reads out programs stored in the ROM 102 into the RAM 103 and executes them to implement operations in the present embodiment. While there is a single CPU in FIG. 1, plural CPUs may be included.

The ROM 102 is a general-purpose ROM and stores programs to be executed by the CPU 101, for example. The RAM 103 is a general-purpose RAM and is used as a working memory for temporarily storing various pieces of information during execution of the programs by the CPU 101, for example.

The HDD 104 is a storage medium (storage unit) for storing image files, databases holding the results of processes, such as image analyses, skeletons to be used by a commercial material creation application, and so on. The HDD 104 is a mere example, and the storage medium is not limited to this. The storage medium may be a solid-state drive (SSD), a flash memory, a cloud storage, or the like.

The display 105 is a display device that displays user interface screens (UI screens) and plural electronic commercial materials obtained as a result of arranging pieces of image data (hereinafter referred to also as “images”) in the present embodiment to the user. The keyboard 106 and the pointing device 107 receive operations as instructions from the user. In the present embodiment, the display 105, the keyboard 106, and the pointing device 107 are separate elements, but the display 105, the keyboard 106, and the pointing device 107 may be integrated into a touch panel having a touch sensor function.

The keyboard 106 is used by the user, for example, to enter conditions for generating one or more commercial materials which the user wants to create into an UI displayed on the display 105. The pointing device 107 is used by the user, for example, to click buttons on UIs displayed on the display 105. The data communication unit 108 performs communication with an external apparatus through, for example, a wired or wireless network. For example, the data communication unit 108 sends pieces of data arranged by an automatic layout function to a printer or server that can communicate with the commercial material generation apparatus 100. The GPU 109 is a processor capable of high-speed data processing by parallel processing. The CPU 101 and the GPU 109 may be caused to cooperate with each other to perform high-speed calculation. A data bus 110 connects the blocks in FIG. 1 communicatively to one another. Note that the configuration illustrated in FIG. 1 is a mere example, and the configuration is not limited to this. For example, the commercial material generation apparatus 100 is not required to include the display 105 and may display UIs on an external display.

The commercial material creation application in the present embodiment is saved in the HDD 104. The commercial material creation application is launched in a case where the user executes an operation, such as a click or a double-click, with the pointing device 107 on the application's icon displayed on the display 105.

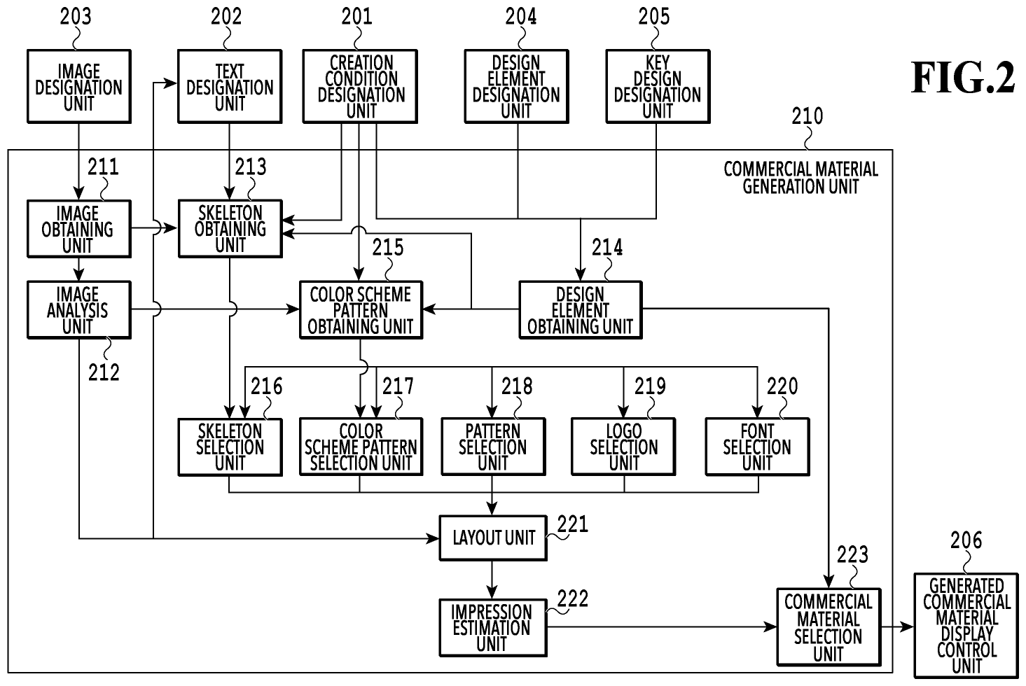

FIG. 2 is a software block diagram of the commercial material creation application. The commercial material creation application includes a creation condition designation unit 201, a text designation unit 202, an image designation unit 203, a design element designation unit 204, a key design designation unit 205, a generated commercial material display control unit 206, and a commercial material generation unit 210. The commercial material generation unit 210 includes an image obtaining unit 211, an image analysis unit 212, a skeleton obtaining unit 213, a design element obtaining unit 214, a color scheme pattern obtaining unit 215, a skeleton selection unit 216, a color scheme pattern selection unit 217, a pattern selection unit 218, and a logo selection unit 219. The commercial material generation unit 210 further includes a font selection unit 220, a layout unit 221, an impression estimation unit 222, and a commercial material selection unit 223.

After the commercial material creation application is installed in the commercial material generation apparatus 100, its launch icon is displayed on the top screen (desktop) of the operating system (OS) running on the commercial material generation apparatus 100. In a case where the user performs an operation (e.g., a double-click operation) with the pointing device 107 on the launch icon displayed on the display 105, the following operation is executed: The program of the commercial material creation application saved in the HDD 104 is loaded to the RAM 103 and executed by the CPU 101, launching the commercial material creation application.

Program modules corresponding to the constituent elements illustrated in FIG. 2 are included in the above commercial material creation application. By executing the program modules, the CPU 101 functions as the constituent elements illustrated in FIG. 2. A description of various processes executed by the constituent elements illustrated in FIG. 2 will now be given below as a description of the constituent elements. Also, FIG. 2 illustrates a software block diagram relating to the commercial material generation unit 210, which executes an automatic commercial material creation function.

The creation condition designation unit 201 designates conditions for creating commercial materials for the commercial material generation unit 210 according to UI operations with the pointing device 107. In the present embodiment, the creation condition designation unit 201 designates the type and purpose category of one or more commercial materials to be created, the number of colors to be added, and whether to generate versions with different backgrounds as the commercial material creation conditions. The size of each commercial material is linked to the type of the commercial material. Further, some commercial materials may have plural sizes. In that case, the creation condition designation unit 201 may designate actual measurements of their widths and heights or designate sheet sizes, such as A1 and A2. The purpose category is a category indicating the purpose of use of the commercial material. Specific examples include “eatery”, “school event”, “sale”, and so on. The number of colors to be added designates the number of colors to be added that are to be used in the commercial material designs to be generated in addition to color information included in a key design designated by the key design designation unit 205 to be described later. The setting on whether to generate versions with different backgrounds designates whether to use background information included in the key design designated by the key design designation unit 205 to be described later as is or to use other backgrounds as well. The creation condition designation unit 201 outputs the designated creation conditions to the skeleton obtaining unit 213, the color scheme pattern obtaining unit 215, and the pattern selection unit 218. In FIG. 2, there is no arrow extending directly to the pattern selection unit 218 from the creation condition designation unit 201, but the designated creation conditions are output to the pattern selection unit 218 through one or more processing units. In the following description, in a case where there is no arrow extending directly to a processing unit of interest, the corresponding information is likewise output to the processing unit of interest through one or more processing units.

The text designation unit 202 designates character information to be arranged on the commercial materials to be generated through UI operations with the keyboard 106. The pieces of character information to be arranged represent character strings indicating a title, a date and time, a location, and the like, for example. The types of the pieces of character information may vary depending on the type of the commercial materials to be created selected by the creation condition designation unit 201. For example, in a case where poster is selected, the text designation unit 202 designates a title, a subtitle, and main text. In a case where postcard is selected, a title, an address, and contact information are displayed. In a case where plural commercial material types are selected, the text designation unit 202 may individually designate overlapping pieces of information or integrate into a single piece of information and designate it. Also, the text designation unit 202 links each piece of character information to type information representing a title, a date and time, a location, or the like, and outputs them to the skeleton obtaining unit 213 and the layout unit 221.

The image designation unit 203 designates one or more pieces of image data to be arranged on the one or more commercial materials, the pieces of image data being saved in the HDD 104. The image designation unit 203 may designate the images to be arranged individually by the type of commercial material to be created selected by the creation condition designation unit 201, or designate common images. The image designation unit 203 may designate each piece of image data based on the structure of the file system including the piece of image data, such as the device or directory, for example, or designate the piece of image data by attached information for identifying the image, such as the date and time of the image capture, or attribute information. The image designation unit 203 outputs the file paths of the designated images to the image obtaining unit 211.

The design element designation unit 204 designates design elements to be reflected in the one or more commercial materials to be created. The design elements to be designated are a color scheme, a pattern, a logo, a font, and a target impression. The design element designation unit 204 further designates a designated design reflection degree for each designated design element indicating the extent to which the design element is reflected in the generated commercial material designs. The design element designation unit 204 designates a color scheme, a pattern, a logo, and a font to be added as items to be selected in the generation of the commercial materials. A target impression is an impression which a commercial material group formed of plural commercial materials is required to finally possess. In the present embodiment, for each of words representing impressions, an intensity indicating how much the impression is to be incorporated is designated by a UI operation with the pointing device 107. The design element designation unit 204 outputs the designated design element information to the design element obtaining unit 214. Details of the “impressions” will be described later. The designation by the design element designation unit 204 does not always need to be performed. For example, the designation may be enabled only in a case where the user designates the design elements of the commercial material designs to be generated. Also, the designated design reflection degree does not need to be designated. In a case where the design elements and the designated design reflection degree are designated, the user can control the designs to generated.

The key design designation unit 205 designates a key design to be reflected in the one or more commercial materials to be created. The key design is a commercial material design created in advance. The key design may be created in advance with the commercial material creation application, or may be a design created with another design creation application. The input format may be raster data, such as JPEG or bitmap (BMP). Alternatively, the input format may be vector data in which a rendering command is written. For example, a common page description language (PDL), such as the Portable Document Format (PDF) proposed by Adobe Inc., Extensible Markup Language (XML) Paper Specification (XPS) proposed by Microsoft Corporation, or Hewlett-Packard Graphics Language/2 (HP-GL/2) proposed by HP Inc, may be used. While the number of key designs may be one, it may be two or more. The key design designation unit 205 outputs the file path of the designated key design to the design element obtaining unit 214.

Next, a configuration of the commercial material generation unit 210 will be described in detail. Different commercial material types can be handled by the skeleton obtaining unit 213 selecting skeletons for the target commercial material types.

The image obtaining unit 211 obtains the one or more pieces of image data designated by the image designation unit 203 from the HDD 104. The image obtaining unit 211 outputs the obtained pieces of image data to the image analysis unit 212. Also, the image obtaining unit 211 outputs the number of obtained images to the skeleton obtaining unit 213. The images saved in the HDD 104 include still images and frame images cut out of moving images. The still images and frame images are images obtained from an image capture device, such as a digital camera or a smart device. The image capture device may be included in the commercial material generation apparatus 100 or included in an external apparatus. Note that in a case where the image capture device is an external device, the images are obtained via the data communication unit 108. Also, in another example, the still images may be illustration images created with image editing software or computer graphics images (CG images) created with computer graphics making software. The still images and the frame images may be images obtained from a network or a server via the data communication unit 108. The images obtained from a network or a server include social networking service images (hereinafter referred to as “SNS images”). Also, a program executed by the CPU 101 analyses data attached to each image to determine the source in which the image is saved. For example, the SNS images may be obtained from an SNS through the application to manage the source from which the images are obtained within the application. Note that the images are not limited to the images described above, and may be other types of images.

The image analysis unit 212 executes an image data analysis process on each piece of image data obtained from the image obtaining unit 211 to obtain information indicating image feature amounts. Specifically, the image analysis unit 212 executes an object recognition process and a main color extraction process to be described later to obtain information indicating image feature amounts of each piece of image data. Also, the image analysis unit 212 links the obtained information indicating the image feature amounts to the corresponding piece of image data and outputs them to the layout unit 221.

The skeleton obtaining unit 213 obtains one or more skeletons matching the conditions designated by the creation condition designation unit 201, the text designation unit 202, the design element obtaining unit 214, and the image obtaining unit 211 from the HDD 104. In the present embodiment, a skeleton is information indicating a layout of one or more character strings, one or more images, one or more figures, and so on to be arranged on plural commercial materials.

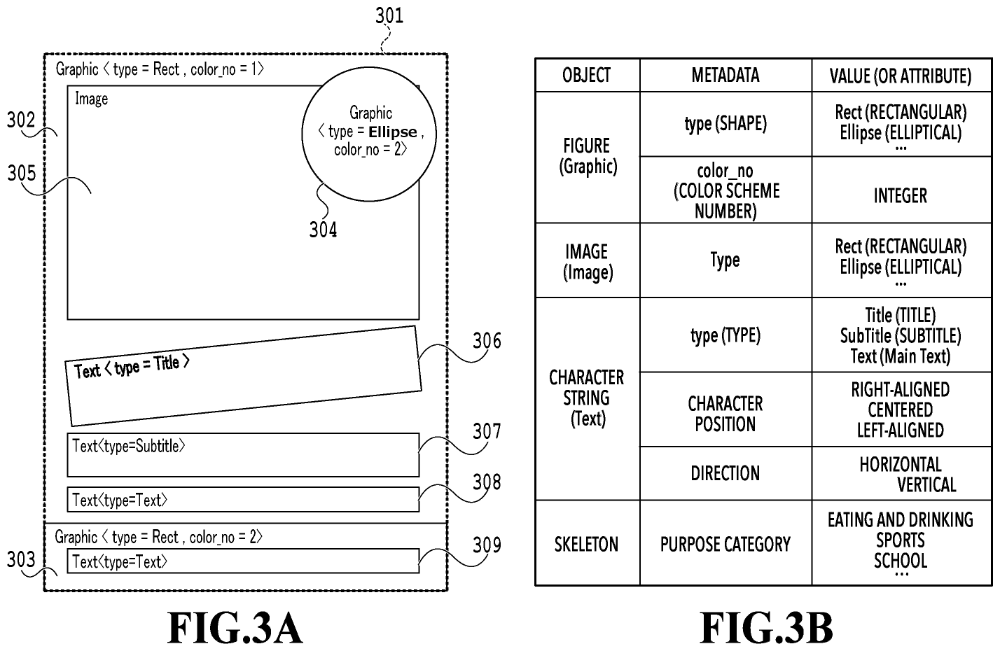

FIGS. 3A and 3B are diagrams illustrating an example of a skeleton for posters among various types of commercial materials. On a skeleton 301 in FIG. 3A, there are arranged three figure objects 302, 303 and 304, one image object 305, and four character objects 306, 307, 308 and 309 in which characters are arranged. For each object, a position indicating where to arrange it, its size, and its angle, as well as metadata necessary for generating the poster are recorded. FIG. 3B is a diagram illustrating an example of the metadata. For example, the character objects 306 to 309 each hold a metadata attribute indicating the type of character information to be arranged. Here, it is indicated that a title is arranged on the character object 306, a subtitle is arranged on the character object 307, and main text is arranged on the character objects 308 and 309. Also, the figure objects 302, 303, and 304 each hold the shape of the figure and a color scheme number (color scheme ID) indicating a color scheme pattern as metadata attributes. Here, attributes of the figure objects 302 and 303 indicate that they are rectangular, and an attribute of the figure object 304 indicates that it is elliptical. Also, the figure object 302 is assigned a color scheme number 1, and the figure objects 303 and 304 are assigned a color scheme number 2. Here, each color scheme number is information to be referred to at the time of arranging the colors, which will be described later, and different color scheme numbers indicate that different colors are assigned. Also, each figure object may be depicted in a solid color. Also, each figure object may be depicted by cutting the pattern of a background illustration or the like into the shape of the figure object. Note that the objects' types and metadata are not limited to these. For example, a map object for arranging a map, a barcode object for arranging a two-dimensional code or a barcode, and the like may be included. Also, the metadata of each character object may include pieces of metadata indicating the width between lines and the width between characters. The metadata may contain the purpose of the skeleton and may be used to control whether to permit using the skeleton based on the purpose.

The skeletons may be sorted and managed by plural commercial materials. Examples include a skeleton for plural commercial material types, a skeleton for menus, a skeleton for postcards, a skeleton for three-folded leaflets, a skeleton for calendars, a skeleton for banners, and so on. Further, some skeletons for different commercial materials may be managed as a group based on the relativity of layout or the like. For example, a first group of skeletons as a skeleton group that gives a sense of luxury may hold the same skeleton group ID in each skeleton' metadata. In this way, based on a skeleton used to create one commercial material, skeletons to be applied to other commercial materials can be determined. Accordingly, in a case of creating the designs of plural commercial materials, skeletons that can generate cohesive designs for the plural commercial materials may be sorted and managed by the ratio of the width to the height. It is possible to obtain skeletons with a width-to-height ratio matching the commercial material size designated by the creation condition designation unit 201. The skeletons may be saved in the HDD 104, for example, in a comma-separated values (CSV) format or in a database format (DB format), such as a structured query language (SQL). The skeleton obtaining unit 213 outputs the one or more skeletons obtained from the HDD 104 to the skeleton selection unit 216.

The design element obtaining unit 214 obtains design elements to be used to generate designs from the design element information designated by the design element designation unit 204 and the key design designated by the key design designation unit 205. The design element obtaining unit 214 extracts a color scheme, a pattern, a logo, a font, and impression values from a key design file designated by the key design designation unit 205. The extracted impression values are set as a target impression. A specific method of extracting the design elements will be described later. The design element obtaining unit 214 merges the design elements extracted from the key design and the respective design elements designated by the design element designation unit 204. In one example, as for the target impression values, an average value of each pair of target impression values is set as a merged target impression value. Alternatively, the target impression value may be the largest value or the smallest value, instead of the average value. In a case where the design element designation unit 204 has designated a reflection degree, the target impression values may be merged at a ratio equal to that reflection degree. Merging the target impression values in this manner can correctly reflect the user's intention. Specifically, the target impression values are merged using Equation (1) as below. The target impression values may be merged after changing the reflection degree to a value of from 0 to 1.

$$Merged Target Inpression Value = Reflection Degree * Designated Target Impression Value + ( 1 - Reflection Degree ) * Extracted Target Impression Value . \qquad Equation ( 1 )$$

Also, as for the other design elements, namely, the color schemes, patterns, logos, and fonts, the design element obtaining unit 214 creates lists and holds the design elements in such a way that those designated by the design element designation unit 204 and those extracted from the key design are distinguishable. The design element obtaining unit 214 outputs the merged pattern or logo to the skeleton obtaining unit 213. Further, the design element obtaining unit 214 outputs the merged target impression values to the skeleton selection unit 216. The design element obtaining unit 214 outputs the merged target impression values and the reflection degree designated by the design element designation unit 204 to the color scheme pattern selection unit 217, the pattern selection unit 218, the logo selection unit 219, the font selection unit 220, and the commercial material selection unit 223. The design element obtaining unit 214 outputs the merged color scheme list to the color scheme pattern obtaining unit 215 and outputs the merged pattern list to the pattern selection unit 218. Further, the design element obtaining unit 214 outputs the merged logo list to the logo selection unit 219 and outputs the merged font list to the font selection unit 220.

The color scheme pattern obtaining unit 215 obtains an image main color list from the image analysis unit 212, the color scheme list from the design element obtaining unit 214, and the number of colors to be added from the creation condition designation unit 201, and obtains color scheme patterns based on these. A “color scheme pattern” is a combination of colors to be used for commercial materials. Further, in a case where the creation condition designation unit 201 has designated colors, the color scheme pattern obtaining unit 215 additionally obtains color scheme patterns including the designated colors from the HDD 104 and outputs them to the layout unit 221.

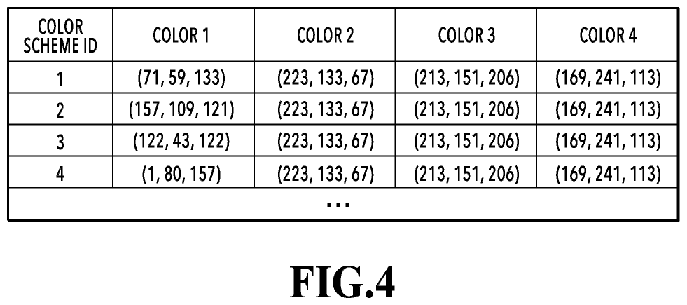

FIG. 4 is a diagram illustrating an example of a color scheme pattern table. In the present embodiment, each color scheme pattern is represented as a combination of four colors. The color scheme ID column in FIG. 4 includes IDs for uniquely specifying respective color scheme patterns. In a case where a newly generated color scheme pattern is stored in the table, the color scheme pattern obtaining unit 215 assigns it an ID other than any of the color scheme IDs that are already used. Although FIG. 4 only includes IDs up to 4, the number of IDs increases as the number of registered color scheme patterns increases. For example, in FIG. 4, color scheme IDs 1 to 4 are stored. In a case where a new color scheme pattern is then stored, the new color scheme pattern is stored in the color scheme pattern table with 5 assigned to the new color scheme pattern as its color scheme ID. The color 1 to 4 columns indicate colors with R, G, and B in this order, and each of the color values of R, G, and B is represented in the range of 0 to 255 ((R, G, B)=(0 to 255, 0 to 255, 0 to 255)). Note that the present embodiment uses color scheme patterns each formed of a combination of four colors, but may use a different number of colors or use plural numbers of colors.

The skeleton selection unit 216 selects one or more skeletons among the skeletons obtained from the skeleton obtaining unit 213 that match the commercial material type designated by the creation condition designation unit 201 and also match the target impressions merged by the design element obtaining unit 214. Then, the skeleton selection unit 216 outputs the selected skeletons to the layout unit 221. The selected skeletons satisfy the following conditions: One or more skeletons are selected for one type of commercial material; and one or more skeletons matching the target impression are selected for each type of commercial material. Since a skeleton determines the layout of whole commercial materials, preparing various types of skeletons in advance can increase the variations of commercial materials to be generated.

The color scheme pattern selection unit 217 outputs one or more color scheme patterns among the color scheme patterns obtained by the color scheme pattern obtaining unit 215 that match the target impression merged by the design element obtaining unit 214 to the layout unit 221. The pattern selection unit 218 outputs one or more patterns matching the target impression merged by the design element obtaining unit 214 from the list of patterns merged by the design element obtaining unit 214 to the layout unit 221. The logo selection unit 219 outputs one or more logos matching the target impression merged by the design element obtaining unit 214 from the list of logos merged by the design element obtaining unit 214 to the layout unit 221.

The font selection unit 220 outputs one or more font patterns matching the target impression merged by the design element obtaining unit 214 from the fonts merged by the design element obtaining unit 214 to the layout unit 221. Each font pattern is a combination of at least one of a title font, a subtitle font, and a main text font.

The layout unit 221 arranges various pieces of data on each of the one or more skeletons obtained from the skeleton selection unit 216 to thereby create one or more types of commercial material data which are more than or equal to the number designated by the creation condition designation unit 201. The layout unit 221 arranges the text obtained from the text designation unit 202 and the pieces of image data obtained from the image analysis unit 212 on the skeletons. Then, the arrangement unit 221 applies the color scheme patterns obtained from the color scheme pattern selection unit 217 to the arranged pieces of image data, and applies the font selected patterns from the font selection unit 220 to the arranged pieces of image data. Further, the arrangement unit 221 arranges the selected patterns from the pattern selection unit 218 on the skeletons. Further, the arrangement unit 221 arranges the selected logos from the logo selection unit 219 on graphic regions in the skeletons. The layout unit 221 outputs the one or more pieces of commercial material data thus generated to the impression estimation unit 222.

The impression estimation unit 222 estimates an impression of each the one or more pieces of commercial material data obtained from the layout unit 221, and links the impression thus estimated (estimated impression) to the piece of commercial material data. Then, the impression estimation unit 222 outputs the one or more pieces of commercial material data with the estimated impressions linked thereto to the commercial material selection unit 223. The commercial material selection unit 223 selects pieces of commercial material data based on the results of comparisons between the target impression merged by the design element obtaining unit 214 and the estimated impressions linked to the plural pieces of commercial material data obtained from the impression estimation unit 222. The selected pieces of commercial material data are saved to the HDD 104. The commercial material selection unit 223 outputs the selected pieces of commercial material data to the generated commercial material display control unit 206.

The generated commercial material display control unit 206 outputs commercial material images to the display 105 according to the pieces of commercial material data obtained from the commercial material selection unit 223. The commercial material images are bitmap data, for example. The generated commercial material display control unit 206 displays the commercial material images on the display 105. The commercial material creation application may be additionally equipped with a function to edit the layouts, colors, shapes, and/or the like of the images, text, and/or graphics in the generated commercial material images with additional user operations after the generated commercial material images are displayed on the display 105 to further change the generated commercial material images to designs which the user wants. Also, the commercial material creation application may be equipped with a function to print the pieces of commercial material data saved in the HDD 104 with a printer under the conditions designated by the creation condition designation unit 201. In this way, the user can obtain printed products of the created commercial materials.

### <<Examples of Display Screens>>

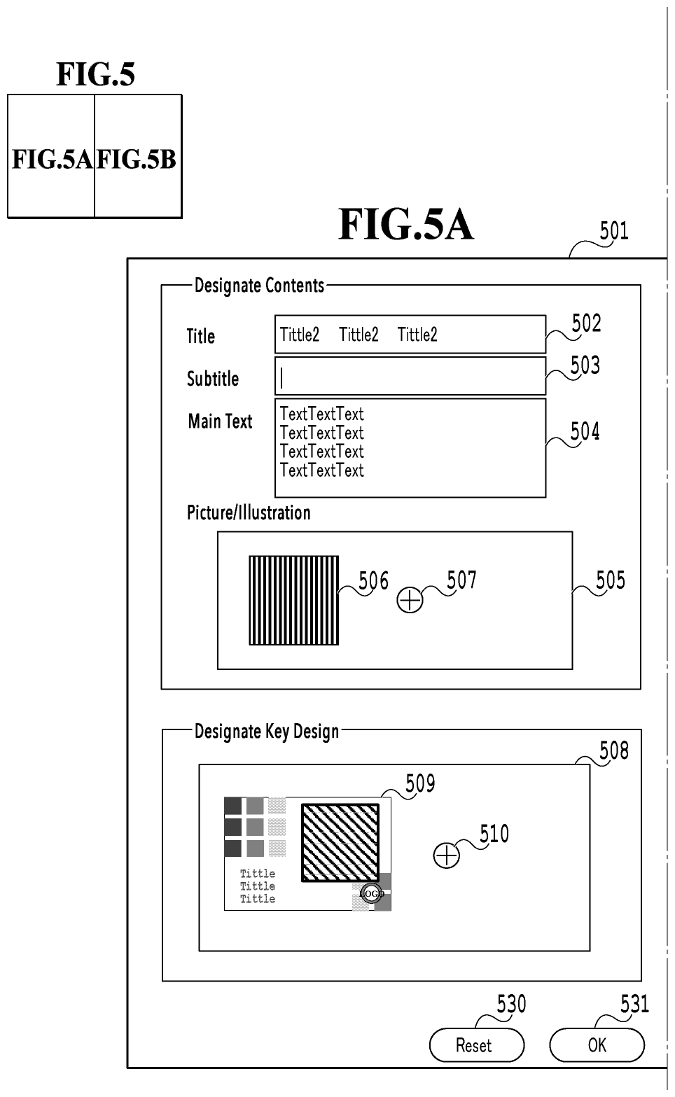

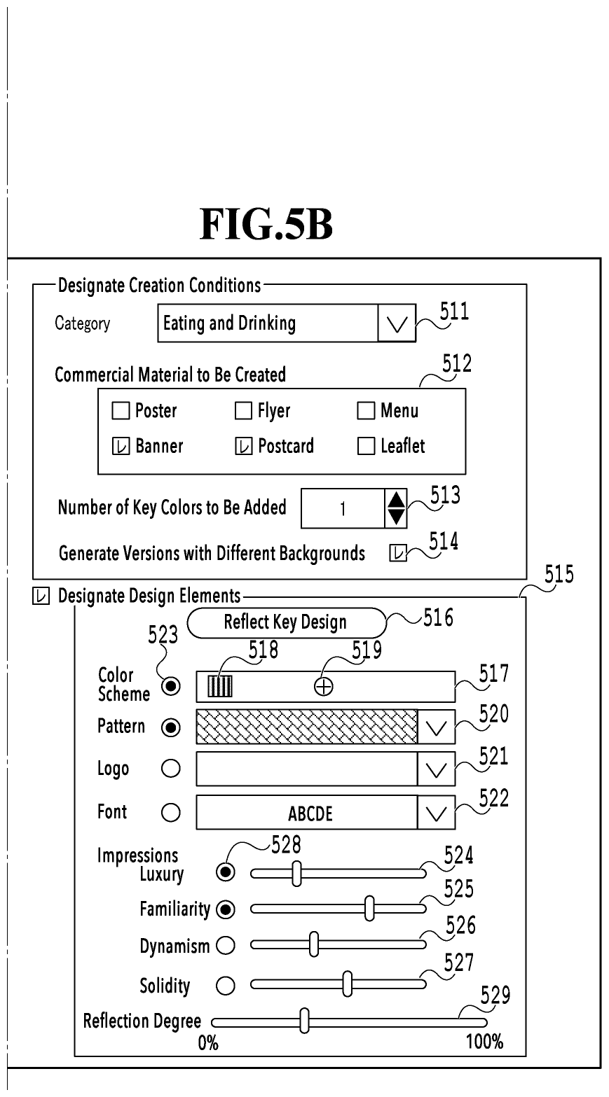

FIGS. 5A and 5B are diagrams illustrating an example of an app launch screen 501 provided by the commercial material creation application. The app launch screen 501 is displayed on the display 105. On the app launch screen 501, the user designates a key design, creation conditions for commercial materials, contents (text and images), and design elements. The creation condition designation unit 201, the text designation unit 202, the image designation unit 203, the design element designation unit 204, and the key design designation unit 205 obtain contents designated by the user through this UI screen.

A title box 502, a subtitle box 503, and a main text box 504 accept designation of character information to be arranged on one or more commercial materials. Incidentally, in the present embodiment, three types of character information are accepted but the types of character information to be accepted are not limited to these. For example, a piece of character information such as a location or a date and time may be additionally accepted. Also, not all pieces of character information need to be designated, and some of the boxes may be left blank. Also, the display may be changed according to what is designated in a to-be-created commercial material designation region 512. For example, in a case where “Poster” is selected, boxes for designating a title, a subtitle, and main text are displayed. In a case where “Postcard” is selected, boxes for designating a title, an address, and contact information are displayed. In a case where plural commercial material types are selected, overlapping boxes may individually designate the same item or may be integrated into a single box and designate the item. Also, the display may be changed according to what is designated in a category designation region 511. For example, in a case where “Eating and Drinking” is selected, boxes for designating an address and contact information are displayed. In a case where “Event” is selected, boxes for designating a venue and a date and time are displayed. The text designation unit 202 obtains the text contents designated by the user through these UI screens.

An image designation region 505 is a region that displays one or more images to be arranged in the commercial materials. An image 506 represents a thumbnail of a designated image. An image addition button 507 is a button for adding images to be arranged. In a case where the user presses the image addition button 507, the image designation unit 203 displays a dialogue screen for selecting files saved in the HDD 104 and accepts selection of image files by the user. Then, thumbnails of the selected images are added to the image designation region 505. Also, images may be designated individually for each of the types of commercial materials to be created selected in the to-be-created commercial material designation region 512 to be described later, or common images may be designated for those commercial material types. The image designation unit 203 obtains the image content designated by the user through this UI screen.

A key design designation region 508 is a region that displays one or more key designs to be used to create the commercial materials. A key design 509 represents a thumbnail of a designated key design. A “key design” is, for example, the design of a commercial material that has already been created or the like. A key design addition button 510 is a button for adding key designs to be arranged. In a case where the user presses the key design addition button 510, the key design designation unit 205 displays a dialogue screen for selecting files saved in the HDD 104 and accepts selection of key design files by the user. Then, thumbnails of the selected key designs are added to the key design designation region 508. The key design designation unit 205 obtains the key design content designated by the user through this UI screen.

The category designation region 511 includes a list box which can set the purpose category of the commercial materials to be created. While the category designation region 511 may be excluded, including the category designation region 511 enables the user to control the generation of commercial materials suitable for a category. The to-be-created commercial material designation region 512 includes plural checkboxes for determining the type of the commercial materials to be created. In this way, the user can select any types of commercial materials to be created from among plural types. The checkboxes for the commercial materials desired to be created can be checked or unchecked by click operations by the user with the pointing device 107. A to-be-added key color count designation region 513 can designate the number of types of key colors to be included in the color scheme pattern that is selected for the creation of the commercial materials. While the to-be-added key color count designation region 513 may be excluded, including the to-be-added key color count designation region 513 can increase the number of key colors to be added, thereby increasing the number of types of key colors in the color scheme pattern to be used in the commercial materials to be generated. This enables the user to control the generation of a wider range of color variations. The different-background designation region 514 includes a checkbox for indicating whether to generate versions with different backgrounds. While the different-background designation region 514 may be excluded, including the different-background designation region 514 enables the user to control whether to generate commercial materials with different backgrounds. The checkbox for generating commercial materials with different backgrounds can be checked or unchecked by a click operation by the user with the pointing device 107. The creation condition designation unit 201 obtains creation conditions from the user through these UI screens.

A design element designation region 515 allows the user to individually designate design elements. The design element designation region 515 includes the following UIs. A color scheme designation box 517 receives information on the colors to be used in the generation of the commercial materials. A color 518 represents a thumbnail of a designated color. A color addition button 519 is a button for adding a designated color. Pressing the color addition button 519 displays a list for designating colors with click operations with the pointing device 107, and the user can designate colors from the list. Also, pressing the color addition button 519 may further display a UI (not illustrated) for designating colors with click operations with the pointing device 107, and the user may designate colors from the UI. The UI is, for example, one on which a color palette with plural colors arranged thereon is displayed and colors can be selected.

A pattern designation box 520 receives information on a pattern to be used in the generation of the commercial materials. In the present embodiment, a list for designating a pattern with a click operation with the pointing device 107 can be displayed, and the user can designate a pattern from the list. Also, a file in which a pattern is saved may be selected and designated by a click operation with the pointing device 107. The file may be an image file (JPEG or BMP) or vector data (PDF).

A logo designation box 521 receives information on a logo to be used in the generation of the commercial materials. In the present embodiment, a list for designating a logo with a click operation with the pointing device 107 can be displayed, and the user can designate a logo from the list. Also, a file in which a logo is saved may be selected and designated by a click operation with the pointing device 107. The file may be an image file (JPEG or BMP) or vector data (PDF).

A font designation box 522 receives information on a font to be used in the generation of the commercial materials. In the present embodiment, a list for designating a font with a click operation with the pointing device 107 can be displayed, and the user can designate a font from the list. Also, a file in which a font is saved may be selected and designated by a click operation with the pointing device 107.

Design element information radio buttons 523 are buttons for controlling whether to enable or disable the settings for the design elements. For each piece of design element information, the user can set whether to enable or disable its setting by pressing the corresponding design element information radio button 523 to turn it on or off. FIGS. 5A and 5B illustrate a state where “Color Scheme” and “Pattern” are enabled.

Impression sliders (hereinafter referred to also as “impression slider bars” or “impression setting sliders”) 524 to 527 are each an object for setting one target impression factor for the one or more commercial materials to be created. For example, the impression slider 524 is a slider for setting a target impression factor related to luxury, and sets the target impression such that the farther the slider is slid toward the left, the more luxurious the commercial materials will appear, and the farther the slider is slid toward the right, the less luxurious (the more modest) the commercial materials will appear. Also, the target impression factors set by the respective impression sliders are combined to set a target impression reflecting not only a target impression factor set by a single impression slider but also target impression factors set by other impression sliders. For example, suppose a case where user operations are performed on the screen of the commercial material creation application to set the impression slider 524 to a right side relative to the center of the slider and set the impression slider 527 to a left side relative to the center of the slider. In that case, commercial materials with an elegant impression, such as commercial materials with a high sense of luxury and a low sense of solidity, are generated. Also, in a case where, for example, user operations are performed to set the impression slider 524 to a right side relative to the center of the slider and set the impression slider 527 to a right side relative to the center of the slider, commercial materials with a gorgeous impression, such as commercial materials with a high sense of both luxury and solidity, are generated. Combining the target impression factors indicated by plural impression sliders as described above makes it possible to set target impressions with different tones, such as an “elegant” target impression and a “gorgeous” target impression for both of which “luxury” is set as a common target impression factor. In sum, the target impression is formed of and determined by plural factors each representing an impression, but may be determined by a single factor representing an impression. In the present embodiment, the value of each slider is corrected to an integer value of from −2 to +2, where −2 represents a state where the slider is set at the leftmost position while +2 represents a state where the slider is set at the rightmost position. These numerical values are values representing the corresponding impression such that −2 is low, −1 is somewhat low, 0 is neither low nor high, +1 is somewhat high, and +2 is high. Note that the value of each slider is corrected to a value of from −2 to +2 for the purpose of aligning with the scale for the corresponding estimated impression to facilitate the later-described distance calculation. The above is a mere example, and a normalization using values from 0 to 1 may be employed.

Impression radio buttons 528 are buttons each of which can control whether to enable or disable the corresponding target impression setting. The user can press any of the impression radio buttons 528 to turn them on or off to thereby set whether to enable or disable the corresponding target impression settings. For example, turning off an impression radio button 528 excludes the corresponding impression from the impression control targets. In a case where, for example, the user wants to create subdued commercial materials with low dynamism and does not particularly specify the other impressions, turning off the impression radio buttons 528 other than that for dynamism can generate commercial materials specifically focused on low dynamism. Incidentally, FIGS. 5A and 5B illustrate a state where the impression radio buttons 528 for luxury and familiarity are turned on and those for dynamism and solidity are turned off. The above configuration enables flexible control that allows the user to choose to use all target impression factors to generate commercial materials or to use only some of the target impression factors to generate commercial materials, for example. Note that a configuration without the impression radio buttons 528 may be employed in a case where setting each slider to the leftmost position is equivalent to disabling the corresponding target impression (e.g., setting the impression slider 524 to the leftmost position sets “luxury” to 0). In this case, to disable each target impression setting, the user can set the corresponding impression slider to the leftmost position to disable the target impression setting.

A reflection degree slider bar 529 sets a weight representing an extent to which the design element information set in the above is reflected in the commercial materials. The weight is 0% at the leftmost position, which is a setting that ignores the input brand information. The weight is 100% at the rightmost position, at which the input brand information will be used fully used. For example, in a case where the reflection degree is designated as illustrated in FIGS. 5A and 5B, the designated design element reflection degree is 40%, indicating that the frequency or probability of the above-described design element obtaining unit 214 using the designated design elements is 40%.

The design element designation region 515 may be provided with a checkbox for enabling the design element designation region 515. The user may check the checkbox to enable designation of design elements in a case where the user wants to individually designate design elements. Unchecking the checkbox to disable the design element designation region 515 sets the designated design element reflection degree to 0%.

The design element designation region 515 may obtain the design elements in each key design designated in the key design designation region 508 and reflect the design elements in the UI. Pressing a key design reflection button 516 sends the key design from the key design designation unit 205 to the design element obtaining unit 214 and extracts the design elements. The design element designation unit 204 shares the extracted design elements and reflects them in the design element designation region 515. In this way, lacking elements or elements to be changed can be easily designated based on the design elements in the key design. The design-table design elements in the design element designation region 515 illustrated in FIGS. 5A and 5B are an example, and other design-related items may be included.

A reset button 530 is a button for resetting the setting information on the app launch screen 501. In a case where the user presses an OK button 531, the creation condition designation unit 201, the text designation unit 202, the image designation unit 203, the design element designation unit 204, and the key design designation unit 205 outputs the contents set on the app launch screen 501 to the commercial material generation unit 210. In doing so, the creation condition designation unit 201 obtains the following information. It is information from the to-be-created commercial material designation region 512 indicating the type of the commercial materials to be created, information from the category designation region 511 indicating the purpose category of the plural commercial materials to be created, information from the to-be-added key color count designation region 513 indicating the number of key colors to be added, and information from the different-background designation region 514 indicating whether generation of versions with different backgrounds is enabled.

The design element designation unit 204 obtains one or more colors from the color scheme designation box 517, a pattern from the pattern designation box 520, a logo from the logo designation box 521, and a font from the font designation box 522. From each design element information radio button 523, the design element designation unit 204 obtains whether the design element information is enabled. From the impression sliders 524 and 527 and the impression radio buttons 528, the design element designation unit 204 obtains the target impression of the plural commercial materials to be created. Further, from the reflection degree slider bar 529, the design element designation unit 204 obtains the reflection degree of the design element information.

From the title box 502, the subtitle box 503, and the main text box 504, the text designation unit 202 obtains the character information to be arranged on the commercial materials. From the image designation region 505, the image designation unit 203 obtains the file paths of the images to be arranged in the commercial materials. From the key design designation region 508, the key design designation unit 205 obtains the file paths of the key design.

Note that the creation condition designation unit 201, the text designation unit 202, the image designation unit 203, the design element designation unit 204, and the key design designation unit 205 may process the values set on the app launch screen 501. For example, the text designation unit 202 may exclude unnecessary blank characters at the heads or ends of any pieces of input character information. Also, the design element designation unit 204 may correct the values of the target impression designated by the impression sliders 524 to 527.

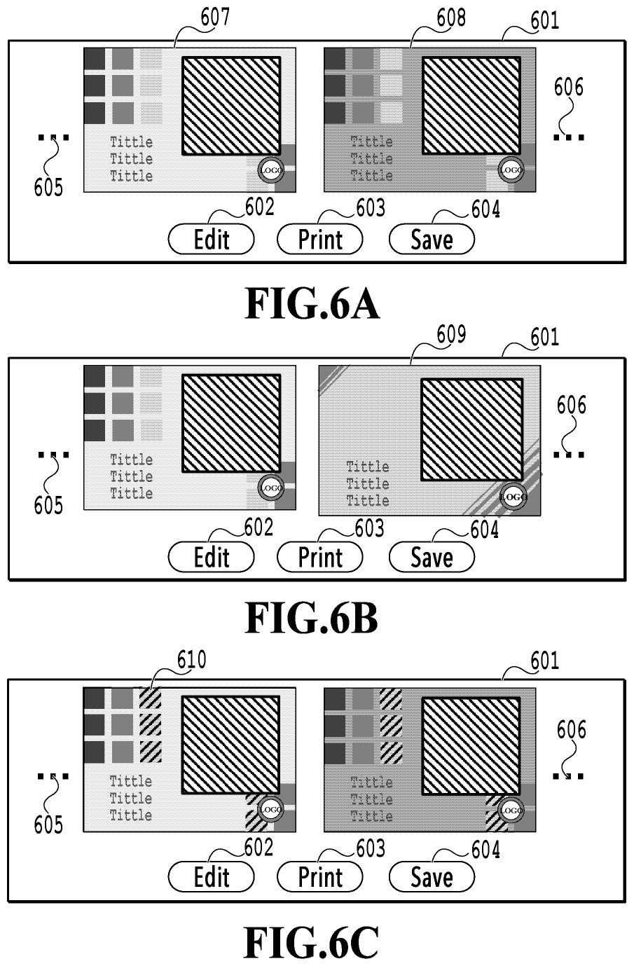

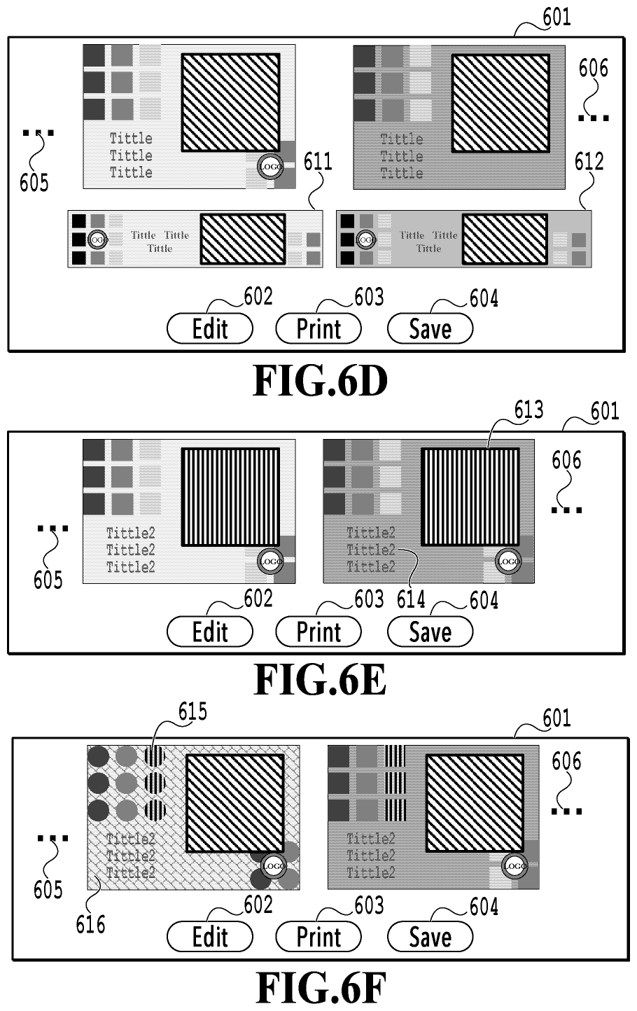

FIGS. 6A to 6F are diagrams illustrating examples of a commercial material preview screen on the display 105 on which plural commercial material images generated by the generated commercial material display control unit 206 are displayed. FIGS. 6A to 6F indicate that the displayed contents are changed by information designated by the user on the app launch screen 501. In response to a press on the OK button 531 on the app launch screen 501, the screen displayed on the display 105 transitions to a commercial material preview screen 601. To generate one or more commercial materials, the commercial material generation unit 210 displays plural commercial material images on the commercial material preview screen 601. In a case where the user clicks one commercial material with the pointing device 107, that commercial material becomes selected. There may be plural selectable commercial materials.

An edit button 602 is a button for editing the one or more selected commercial materials through a UI not illustrated that provides an editing function. A print button 603 is a button for printing the plural displayed types of commercial materials through a printer control UI not illustrated. A save button 604 is a button for saving the plural displayed types of commercial materials to the HDD 104 in a predetermined format that supports re-editing of the commercial materials. The predetermined format may be a CSV format or the JSON format. The saved information includes estimated impressions of the commercial materials and brand information (logo, pattern, key colors, and font).

A next candidate display button 606 is a button for displaying generated commercial material images that are not displayed. The number of commercial materials that can be displayed on the commercial material preview screen 601 is determined in advance by the screen size, and the next candidate display button 606 becomes active in a case where the number of commercial materials generated exceeds the number of commercial materials that can be displayed. Pressing the next candidate display button 606 displays commercial materials that have not been displayed and hides the displayed commercial materials. The commercial materials may become hidden one by one, or plural commercial materials may become hidden. The number of commercial materials to be hidden may be set by the user from a region (not illustrated where the user designates the number of commercial materials to be hidden.

A previous candidate display button 605 is a button for re-displaying commercial materials that became hidden as a result of pressing the next candidate display button 606. Pressing the next candidate display button 606 makes the previous candidate display button 605 active. Pressing the previous candidate display button 605 displays the commercial materials that were displayed before the next candidate display button 606 was pressed, and hides the commercial materials that have been displayed as a result of the press on the next candidate display button 606.

How information set by the user on the app launch screen 501 is displayed as a difference in the displayed commercial material preview screen will be described in detail using FIGS. 6A to 6F. FIG. 6A is a diagram illustrating an example of the commercial material preview screen in a case where the user has designated, on the app launch screen 501, one type for the commercial materials to be created, one key design, and one as the number of key colors to be added, has input no contents or design elements, and has disabled generation of versions with different backgrounds as the setting information. Commercial material images 607 and 608 represent an example of commercial material images generated using design elements extracted from the key design designated in the key design designation region 508. The commercial material images 607 and 608 are illustrated to be different only in background color. This setting enables the background color to be changed while the key design maintained, and thus allows for generation of appropriate commercial material designs representing a brand's impression intended by the user from combinations of the set key design and the generated commercial materials.

FIG. 6B is a diagram illustrating an example of the commercial material preview screen in a case where the setting information on the app launch screen 501 is such that the generation of versions with different backgrounds is enabled, unlike the setting information in FIG. 6A. FIG. 6B illustrates an example where the background of a commercial material image 609 is changed, unlike FIG. 6A. Enabling the generation of versions with different backgrounds makes it possible to generate commercial materials with a wide range of background variations. This increases the variations of commercial material designs which the user can select from, allowing for generation of an appropriate combination of commercial material designs representing the brand's impression that match the user's intention better.

FIG. 6C is a diagram illustrating an example of the plural commercial material preview screen in a case where the setting information on the app launch screen 501 is such that the number of key colors to be added is increased as compared to the setting information in FIG. 6A. FIG. 6C is a diagram illustrating an example where the number of colors used is increased as compared to FIG. 6A. A color 610 represented by the diagonal stripes extending from bottom left to top right is the color added to the colors in the commercial material image 607. Increasing the number of key colors to be added increases the number of colors to be used per commercial material, allowing for generation of commercial materials with a new brand image. This increases the variations of commercial material designs which the user can select from, allowing for generation of an appropriate combination of commercial material designs representing the brand's impression that match the user's intention better.

FIG. 6D is a diagram illustrating an example of the commercial material preview screen in a case where the setting information on the app launch screen 501 is such that plural commercial material types are selected, unlike the setting information in FIG. 6A. FIG. 6D illustrates an example where commercial material images 611 and 612 are added as a result of the selected commercial material types, unlike FIG. 6A. Selecting plural commercial material types allows for generation of plural types of commercial materials at once and generation of combinations for different types of commercial materials. This allows for generation of appropriate commercial material designs representing the brand's impression from combinations of plural types of commercial materials which the user wants to create.

FIG. 6E is a diagram illustrating an example of the commercial material preview screen in a case where the setting information on the app launch screen 501 is such that contents are set, unlike the setting information in FIG. 6A. FIG. 6E illustrates an example in which title text 614 and images 613 are changed by the set contents from those in FIG. 6A. By setting contents, the user can control the contents to be included in the commercial materials to be generated. In this way, it is possible to generate an appropriate combination of commercial material designs representing the brand's impression that matches the user's intention using contents set by the user.

FIG. 6F is a diagram illustrating an example of the commercial material preview screen in a case where the setting information on the app launch screen 501 is such that design elements are set, unlike the setting information in FIG. 6A. FIG. 6F illustrates an example where the pattern shape and color of an illustration 615 and the pattern of a background 616 are changed by the set design elements from those in FIG. 6A. Specifically, the shape of the illustration 615 has been changed as a result of changing the impression values of design elements. The color of the illustration 615 has been changed by the color scheme serving as a design element. The background pattern 616 has been changed by the pattern serving as a design element. By setting design elements, the user can control the designs of the commercial materials to be generated.

In this way, it is possible to generate an appropriate combination of commercial material designs representing the brand's impression while the user controls the designs.

### <<Quantification of Impressions of Plural Commercial Materials>>

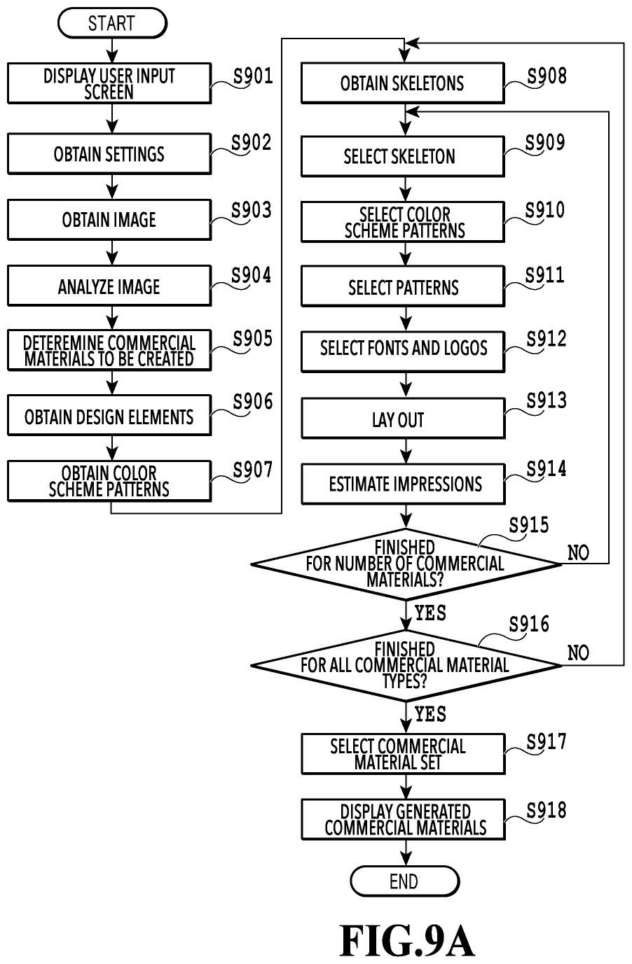

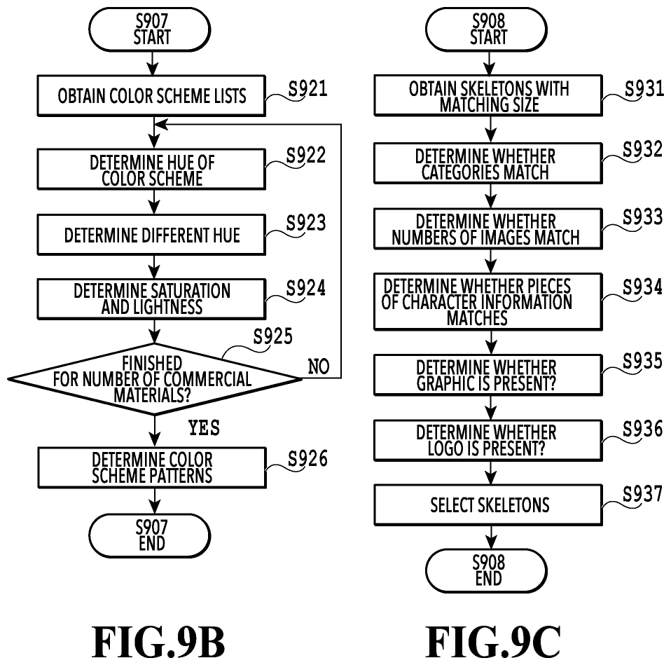

Now, a description will be given of the method of a process of quantifying impressions of plural commercial materials as preprocessing for executing the impression estimation process to be described later in S914 in FIG. 9A, which is necessary for a commercial material generation process. In the present embodiment, the description will be given using a process of quantifying impressions of posters as an example. The impressions of other commercial materials can be quantified by performing similar processes. Also, in a case where commercial materials are similar to each other in size or purpose, the result of quantification of one commercial material's impression may be used as the result of quantification of the other commercial material's impression.

The process of quantifying impressions of posters is performed at the development stage of a post creation application by a vendor that develops the poster creation application or the like. Note that the commercial material generation apparatus 100 may execute the process of quantifying impressions of posters or an information processing apparatus other than the commercial material generation apparatus 100 may execute it. In a case where an information processing apparatus other than the commercial material generation apparatus 100 executes the process of quantifying impressions of posters, the CPU of this information processing apparatus executes it.

The process of quantifying impressions of posters involves quantifying impressions that people have of various posters. Simultaneously, the process involves deriving the correspondences between images of the posters and the impressions of the posters. In this way, it is possible to estimate impressions of posters from generated images of the posters. In a case where the impressions can be estimated, it is possible to correct the poster images to control the impressions of the posters or search for poster images having a target impression. Note that the poster impression quantification process is executed by, for example, causing an impression learning application for learning impressions of poster images in advance to operate in the commercial material generation apparatus 100 before the poster generation process.

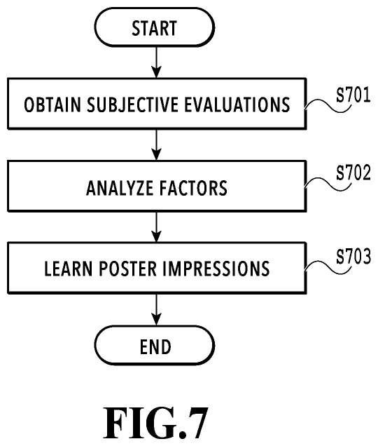

FIG. 7 is a flowchart illustrating the process of quantifying impressions of posters. The CPU 101 implements the flowchart illustrated in FIG. 7 by reading out a program stored in the HDD 104 into the RAM 103 and executing it, for example. The process of quantifying impressions of posters will now be described with reference to FIG. 7.

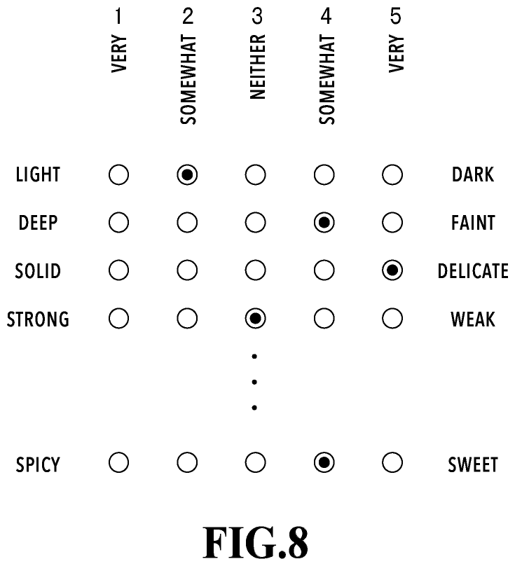

In S701, the CPU 101 obtains subjective evaluations on impressions of posters. FIG. 8 is a diagram describing an example of a method of obtaining subjective evaluations on impressions of a poster. The CPU 101 presents the posters to plural evaluators and obtains the plural evaluators' subjective evaluations on impressions of those posters. For this, a measurement method such as the semantic differential (SD) method or Likert scale method. is used. FIG. 8 illustrates an example of a questionnaire using the SD method, in which pairs of adjectives representing impressions are presented to the plural evaluators, and the evaluators rate a target poster based on how they feel about the poster with the adjective pairs. The CPU 101 obtains the results of the plural evaluators' subjective evaluations on the plural posters, and then calculates an average value of their answers for each adjective pair and sets the average value as a representative numerical value of the corresponding adjective pair. Note that the impression subjective evaluation method may be any method other than the SD method as long as words representing impressions and scores corresponding to those can be determined.

In S702, the CPU 101 executes a factor analysis on the results of the subjective evaluations obtained by a subjective evaluation obtaining unit. In a case where the results of the subjective evaluations are used as is, the number of adjective pairs will be the number of dimensions, which will result in complicated control. For this reason, it is desirable to reduce the number of dimensions to an efficient number by an analysis method, such as principal component analysis or factor analysis. The present embodiment will be described on the assumption that the dimensions are reduced to four factors by factor analysis. This number varies by the selection of adjective pairs in the subjective evaluation or the factor analysis method, as a matter of course. Also, the output of the factor analysis is assumed to be standardized. That is, each factor is scaled such that the mean is 0 and the variance is 1 for the posters used in the analysis. In this way, −2, −1, 0, +1, and +2 as the impressions designated by the design element designation unit 204 directly correspond to −20, −10, the mean, +10, and +20 for the impressions, which facilitates the later-described distance calculation between the target impression and estimated impressions. In the present embodiment, the four factors are “Luxury,” “Familiarity,” “Dynamism,” and “Solidity” shown in FIGS. 5A and 5B. These are names given for the sake of convenience in indicating the impressions to the user through a user interface, and each factor is formed of plural adjective pairs affecting each other.

In S703, the CPU 101 associates the poster images and the impressions. While the posters subjected to the subjective evaluation by the above-described method can be quantified, it is necessary to estimate impressions on posters to be created with no subjective evaluation. The association between the poster images and the impressions can be done by, for example, training a model that estimates an impression from a poster image by a deep learning method using a convolution neural network (CNN), a machine learning method using a decision tree, or the like. In the present embodiment, an impression learning unit performs supervised deep learning using a CNN with the poster images as inputs and the four factors as outputs. That is, the impression learning unit creates a deep learning model through training in which the poster images subjected to the subjective evaluation and the corresponding impressions are defined as correct, and inputs an unknown poster image into that learning model to estimate its impression.

Note that the deep learning model created above is saved to the HDD 104, for example, and the impression estimation unit 222 loads the deep learning model saved in the HDD 104 to the RAM 103 and executes it. The impression estimation unit 222 converts poster data obtained from the layout unit 221 into an image, and runs the deep learning model loaded in the RAM 103 on the CPU 101 or the GPU 109 to estimate the impression of the poster. In the present embodiment, a deep learning method is used, but the learning method is not limited to this. For example, in a case of using a machine learning method with a decision tree, a machine learning model may be created which extracts a feature amount such as an average value of luminance and the amount of edges in a poster image by an image analysis and estimates its impression based on that feature amount.

FIG. 9A is a flowchart illustrating a commercial material generation process by the commercial material generation unit 210 of the commercial material creation application. The flowchart illustrated in FIG. 9A starts in response to the user pressing an OK button after various setting items are set on the commercial material creation application, as described above. The CPU 101 implements the flowchart illustrated in FIG. 9A by reading out a program stored in the HDD 104 into the RAM 103 and executing it, for example. The present embodiment will be described on the assumption that the process is executed by the constituent elements illustrated in FIG. 2 which are caused to operate by the CPU 101 executing the above-described commercial material creation application. The commercial material generation process will now be described with reference to FIG. 9A.

In S901, the commercial material creation application displays the app launch screen 501 on the display 105. The user inputs settings into the UI screen of the app launch screen 501 using the keyboard 106 or the pointing device 107.

In S902, the creation condition designation unit 201, the text designation unit 202, the image designation unit 203, the design element designation unit 204, and the key design designation unit 205 obtains the corresponding settings from the app launch screen 501. The creation condition designation unit 201 obtains one or more types of commercial materials to be created, a category, the number of key colors to be added, and information on whether to generate versions with different backgrounds. As the one or more types of commercial materials to be created, the one or more types of commercial materials to be created in the to-be-created commercial material designation region 512 are obtained. FIGS. 5A and 5B indicate that there are two types of commercial materials to be created, namely “Banner” and “Postcard.” As the category, the category in the category designation region 511 is obtained. FIGS. 5A and 5B indicate that the category is “Eating and Drinking.” The number of key colors to be added designates the number of key colors to be added to the commercial materials to be created. FIGS. 5A and 5B indicate that the number of key colors to be added is one. The information on whether to generate versions with different backgrounds designates whether to change the backgrounds of commercial materials to be created from that in the key design. FIGS. 5A and 5B indicate that the backgrounds of commercial materials are to be changed. The text designation unit 202 obtains character information to be arranged on the plural commercial materials from the title box 502, the subtitle box 503, and the main text box 504. FIGS. 5A and 5B indicate that: “Tittle2Tittle2Tittle2” is to be obtained as the title; a blank is to be obtained as the subtitle; and four lines of “TextTextText” are to be obtained as the main text. The image designation unit 203 obtains the one or more images designated in the image designation region 505. FIGS. 5A and 5B indicate that an image of vertical strips is to be obtained. The design element designation unit 204 obtains a color scheme, a pattern, a logo, a font, impressions, and a reflection degree for the color scheme, the pattern, the logo, the font and the impressions. As the color scheme, the one or more colors designated in the color scheme designation box 517 are obtained. Further, whether to use the color scheme in the generation of the commercial materials is obtained from the corresponding design element information radio button 523. FIGS. 5A and 5B indicate that the color scheme is the color represented as vertical stripes and is to be used in the generation of the commercial materials. As the pattern, the pattern designated in the pattern designation box 520 is obtained. Further, information on whether to use the pattern in the generation of the commercial materials is obtained from the status of the corresponding radio button. FIGS. 5A and 5B indicate that the pattern is a tilted brick pattern and is to be used in the generation of the commercial materials. As the logo, the logo designated in the logo designation box 521 is obtained. Further, information on whether to use the logo in the generation of the commercial materials is obtained from the status of the corresponding radio button. FIGS. 5A and 5B indicate that no logo is designated and is to be used in the generation of the commercial materials. As the font, the font designated in the font designation box 522 is obtained. Further, information indicating whether to use the font in the generation of the commercial materials is obtained from the status of the corresponding radio button. FIGS. 5A and 5B indicate that a Gothic font is designated as the font but is not to be used in the generation of the commercial materials. As the impressions, target impression factors are obtained from the setting values of the impression sliders 524 to 527. Further, whether to use the setting values as the target impression is obtained from the respective impression radio buttons 528. FIGS. 5A and 5B indicate that luxury is −1, familiarity is +1, dynamism is −0.8, and solidity is 0. FIGS. 5A and 5B further indicate that luxury and familiarity are to be used as the target impression and dynamism and solidity are not to be used as the target impression. The key design designation unit 205 obtains the one or more key designs designated in the key design designation region 508. FIGS. 5A and 5B indicate that the key design 509 is to be obtained.

In S903, the image obtaining unit 211 obtains image data. Specifically, the image obtaining unit 211 specifies image files corresponding to the images in the settings obtained in S902. Then, the image obtaining unit 211 reads the image data of the specified image files out of the HDD 104 into the RAM 103.

In S904, the image analysis unit 212 executes an analysis process on the image data obtained in S903, and obtains information indicating feature amounts. Examples of the information indicating feature amounts include meta information contained in the images and information indicating image feature amounts that can be obtained by analyzing the images. These pieces of information will be used in an object recognition process and a main color extraction process, which are analysis processes. In the present embodiment, an object recognition process and a main color extraction process are executed as analysis processes, but the processes are not limited to these. Other analysis processes may be executed. Further, the process of S904 may be omitted.

Details of the process performed in S904 by the image analysis unit 212 will now be described below. The image analysis unit 212 executes an object recognition process on each image obtained in S903. Here, publicly known methods are usable for the object recognition process. In the object recognition process, a classifier created by deep learning recognizes objects. The classifier outputs a value of from 0 to 1 as a likelihood indicating whether a pixel forming the image is a pixel forming an object and, in a case where an object exceeds a threshold value, recognizes that the object is included in the image. By recognizing object images, the image analysis unit 212 can obtain the types and positions of objects, such as pets, including dogs, cats, and the like, flowers, food, buildings, ornaments, and landmarks. Further, the image analysis unit 212 executes a main color extraction process on each image obtained in S903. Here, publicly known methods are usable for the main color extraction process. In the present embodiment, the number of pixels is counted for each pixel value, and the most frequent value is determined to be a main color. Using pixel values may result in a situation where similar colors in gradation or the like are processed as different colors, which is not suitable for determining a main color. The number of pixels may be counted such that pixels with color differences within a predetermined range are grouped as the same color. In this way, a main color can be set with similar colors taken into account, and a main color as perceived by humans can be extracted. Further, not only the number of pixels but also the saturation and lightness of the extracted pixel values and the color differences between the extracted pixels and the peripheral pixels therearound may be used to calculate main color levels. Colors with high saturation, light colors, and dark colors stand out and are therefore tended to be recognized as main colors. Also, the colors of pixels with large color differences from the peripheral pixels therearound stand out and are therefore tended to be recognized as main colors. Specifically, the main color levels are calculated such that: the higher the saturation, the higher the main color level; the farther the lightness from gray, the higher the main color level; and the larger the color difference from the peripheral pixels, the higher the main color level. Equation (2) represents an example equation for the calculation.

$$Main Color Level Mc = Pn * ( S + \vert 50 - L \vert + Δ E ) , \qquad Equation ( 2 )$$

where Pn is the number of pixels, S is the saturation, L is lightness, and ΔE is the color difference from the peripheral pixels.

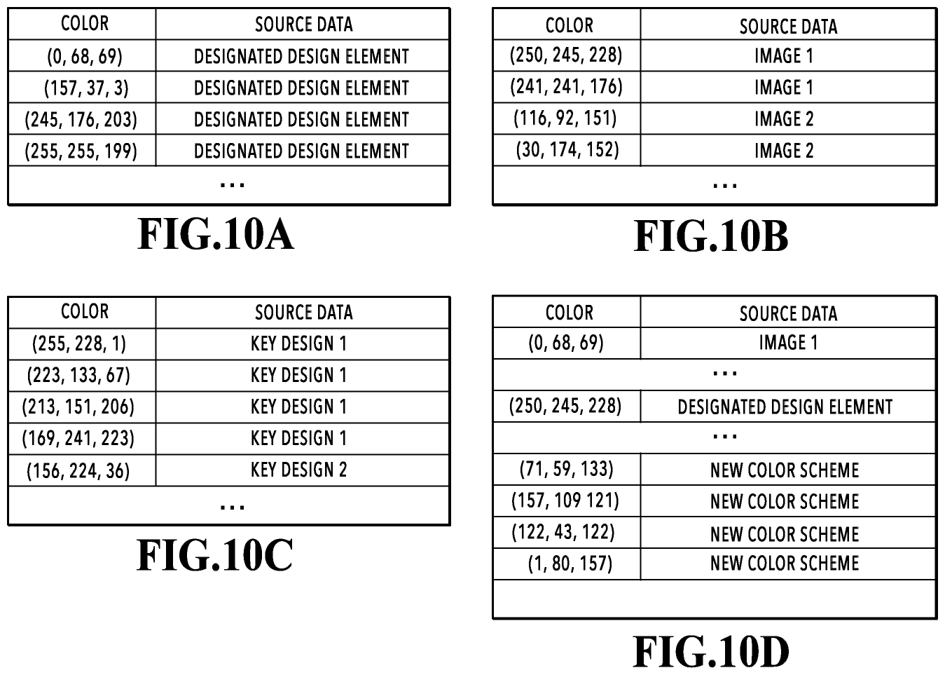

The color whose main color level Mc calculated by the above equation is highest is extracted as the main color. In this way, it is possible to extract a main color as perceived by humans. Also, the main color extraction process may involve extraction using a classifier created by deep learning or extraction using a clustering method, such as K-means. Also, there may be plural main colors, instead of only one main color. The extracted main color is stored in the RAM 103 in a list in a format indicating that it represents a color scheme extracted from the image. FIG. 10B illustrates a list of color schemes extracted by the image analysis unit 212. The image analysis unit 212 holds the RGB values of colors and the type of the source data as “Image 1” in a table format in the RAM 103. In the case where there are plural images, the image analysis unit 212 additionally names the type of the source data as “Image 2” or the like and holds it in the RAM 103 in a format indicating which color scheme was extracted from which image.

In S905, the types of commercial materials to be created, and the number of commercial materials to be created per commercial material type are determined. The types of commercial materials to be created correspond to the number of commercial material types obtained in S902. It is two in FIGS. 5A and 5B. Further, for each commercial material type, a number of commercial materials determined in advance is set as the number of commercial materials to be created. The number of commercial materials may be designated by a setting (not illustrated) in the app launch screen 501 in FIGS. 5A and 5B. This number of commercial materials affects the time required to generate the commercial materials and variations to be generated. Increasing the number of commercial materials can increase the number of variations but lengthens the generation time. Decreasing the number of commercial materials reduces the number of variations but can shorten the generation time. The user can designate whether to focus on the number of variations of the commercial materials to be generated or to focus on the length of the generation time by designating the setting in the app launch screen 501 in FIGS. 5A and 5B. In this way, the user can control the number of variations of the commercial materials to be generated and the length of the generation time. In the present embodiment, the number of commercial materials is five. That is, in FIGS. 5A and 5B, it is determined that 5 postcards and 5 banners, i.e., a total of 10 commercial materials, are to be created. In the present embodiment, a combination of commercial materials including one commercial material per commercial material type will be referred to as “commercial material set.” In FIGS. 5A and 5B, plural commercial material sets are generated each of which is a combination of two commercial materials being one postcard and one banner. In the present embodiment, the number of commercial materials to be created is five but may be another number. The larger the number of commercial materials to be created, the more likely a commercial material set is generated which is close to the target impression and has high similarity in design between the commercial materials. The smaller the number of commercial materials to be created, the faster the generation process will be executed. The processes of S908 to S915 to be described later are iterated as many times as the number of types of commercial materials to be created. Further, the processes of S909 to S914 are iterated as many times as the number of commercial materials to be created. That is, the processes of S909 to S914 are iterated as many times as (the number of types of commercial materials to be created * the number of commercial materials to be created). In the present embodiment, the number of types of commercial materials to be created is two and the number of commercial materials to be created is five, and therefore the processes of S909 to S914 are iterated 10 times.

In S906, the design element obtaining unit 214 obtains design elements to be used for the commercial materials to be created. Specifically, the design element obtaining unit 214 extracts design elements from each key design designated by the key design designation unit 205. In a case where the key design is vector data, the design element obtaining unit 214 extracts a color scheme, a pattern, a logo, and a font from its tag information. For example, in a case where the key design is stored in the form of Scalable Vector Graphics (SVG) data, the design element obtaining unit 214 extracts a large depiction region as a pattern and a small depiction region as a logo. In a case where a font name is in a text tag region, the design element obtaining unit 214 extracts it as a font. The design element obtaining unit 214 extracts the color scheme from color values included in tag data. Also, the vector data may be rasterized and then subjected to the above-described main color extraction process to obtain color scheme information from the raster data. Also, in a case where the key design is raster data, the color scheme, the pattern, the logo, and the font may be obtained after image region separation by a model trained by machine learning, such as deep learning. The color scheme, the pattern, the logo, and the font extracted from each key design are stored in a color scheme list, a pattern list, a logo list, and a font list in the RAM 103, respectively. Further, the design element obtaining unit 214 obtains the design elements designated by the design element designation unit 204. The obtained color scheme, pattern, logo, and font are stored in the respective lists. In a case where the actual data of the pattern, logo, and font stored in the lists have been saved in the HDD 104 in advance, they are sequentially loaded to the RAM 103. In a case where they are raster data, images are cut out from the result of image region separation and sequentially stored in the RAM 103. In the color scheme list, the color schemes extracted from the key designs and the color scheme designated by the design element designation unit 204 are held in such a format as to be distinguishable from each other. The color scheme list will now be described in detail using FIGS. 10A to 10D. FIG. 10A illustrates a list of color schemes obtained by the design element designation unit 204. The design element obtaining unit 214 holds the RGB values of the colors and the type of the source data as “Designated Design Element” in a table format in the RAM 103. FIG. 10C illustrates a list of color schemes obtained from the key designs. The design element obtaining unit 214 holds, in the RAM 103, the RGB values of colors and the type of the source data as “Key Design 1” in a table format. FIG. 10C indicates that the color scheme extracted from “Key Design 1” includes four colors. In the case where there are plural key designs, the design element obtaining unit 214 additionally names the type of the source data as “Key Design 2” or the like and holds it in the RAM 103 in a format indicating which color scheme was extracted from which key design.

In S907, the color scheme pattern obtaining unit 215 obtains color scheme patterns to be used for the commercial materials to be created. FIG. 9B is a flowchart illustrating a process by which the color scheme pattern obtaining unit 215 obtains color scheme patterns. The color scheme pattern obtaining process will now be described in detail using FIG. 9B.

In S921 in FIG. 9B, the color scheme pattern obtaining unit 215 obtains the color scheme list illustrated in FIG. 10B from the image analysis unit 212 and the color scheme list illustrated in FIG. 10A or 10C from the design element obtaining unit 214. The color scheme pattern obtaining unit 215 registers the color scheme list obtained from the image analysis unit 212 (FIG. 10B) in a new color scheme list and stores it in the RAM 103. In this way, it is possible to obtain a color scheme matching an image designated by the user. The color scheme pattern obtaining unit 215 also registers the list of color schemes designated by the design element designation unit 204 (FIG. 10A), of the color scheme lists that can be obtained from the design element obtaining unit 214, in the new color scheme list. FIG. 10D illustrates the new color scheme list. The color scheme pattern obtaining unit 215 holds the RGB value of each color and the type of its source data as “New Color Scheme” in a table format in the RAM 103. The color scheme list to be used in the process of S922 is the list of color schemes extracted from the key designs designated by the key design designation unit 205 (see FIG. 10C).

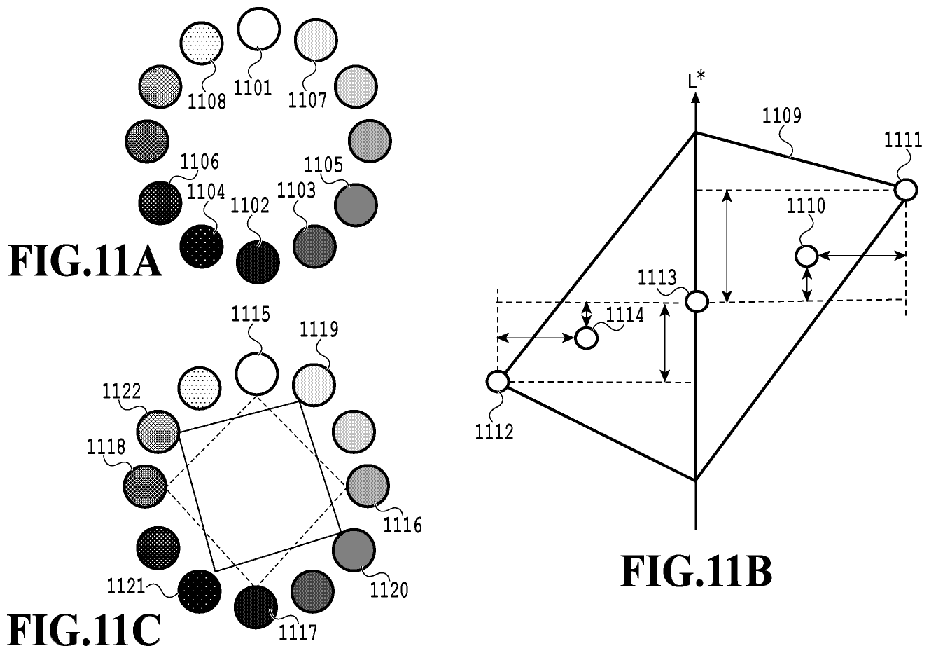

In S922, the color scheme pattern obtaining unit 215 selects one color scheme from the color scheme list determined in the process of S921, and determines the hue of the color of that color scheme. A specific determination method will now be described using FIG. 11A. FIG. 11A represents a color wheel indicating that a hue angle range of 0 to 360 degrees is divided by 12 representative colors. For example, FIG. 11A indicates that the representative colors include a color 1101 followed by yellow, yellow-green, green, blue-green, blue, blue-purple, purple, red-purple, red, red-orange, orange, and yellow-orange in the clockwise direction. The color scheme pattern obtaining unit 215 determines which hue the selected color scheme corresponds. The color scheme pattern obtaining unit 215 calculates the hue angle of the selected color scheme to each hue, and determines the closest color to the hue angle of the selected color scheme. The color scheme pattern obtaining unit 215 sets the color with that closest hue as the hue of the selected color scheme.

In S923, from the hue of the selected color scheme, the color scheme pattern obtaining unit 215 determines the hues of one or more new color schemes as candidates. The new color schemes have hues that are different from the hue of the selected color scheme. Specifically, the new color schemes each have a hue that, in relation to the hue of the selected color scheme, is a complementary color, a contrasting color close to the complementary color, or a similar color close to the hue of the selected color scheme. Assuming that the color 1101 in FIG. 11A is the hue of the selected color scheme, the complementary color is a color 1102, the contrasting color is any of colors 1103 to 1106, and the similar color is a color 1107 or 1108. From among the candidate colors 1102 to 1108, the color scheme pattern obtaining unit 215 determines a number of colors corresponding to the number of key colors to be added from the creation condition designation unit 201 as the hues of the one or more new color schemes. In FIGS. 5A and 5B, the number of key colors to be added is one, and therefore the color scheme pattern obtaining unit 215 determines the hue of one new color scheme. As for the determination method, the hues of the one or more new color schemes may be selected at random. For example, the hues of the new color schemes may each be a color defined by rotating the color wheel by a predetermined angle in the clockwise direction or the counterclockwise direction. Also, the predetermined angle may be 30 degrees or 60 degrees. More preferably, the hues of the new color schemes are determined according to the target impression values obtained by the design element obtaining unit 214. Specifically, based on impressions which the candidate hues have, the hue that has the closest impression to the target impression is determined. For example, red, red-orange, yellow, or yellow-orange is determined in a case where the numerical value of dynamism is high, and blue-purple, blue, or blue-green is determined in a case where the numerical value of dynamism is low. Also, orange, yellow-orange, yellow, yellow-green, or green is determined in a case where familiarity is high, red-purple, purple, blue-purple, or blue is determined in a case where familiarity is low. Also, the hues may be determined according to the target impression and the hue relationship. For example, a hue that is the complementary color or a contrasting color may be determined in a case where the numerical value of dynamism is high, and a similar color may be determined in a case where the numerical value of dynamism is low. In this way, it will be possible to generate commercial materials with a color scheme matching the target impression set by the user.

In S924, the color scheme pattern obtaining unit 215 determines saturation and lightness based on the hue of the selected color scheme and the hue of each new color scheme determined in S923. Specifically, the color scheme pattern obtaining unit 215 sets the lightness and saturation of each new color scheme to the lightness and saturation of the selected color scheme and sets the hue to the hue of the new color scheme. As a result, each new color scheme is determined to be a color that has a different hue from that of the selected color scheme and has the same lightness and saturation as those of the selected color scheme. Each determined color scheme is stored in the new color scheme list (FIG. 10D). A color with the same lightness and saturation means such a color that the lightness difference and the saturation difference between the selected color scheme and the determined color scheme are within respective predetermined ranges. Also, the determined color scheme includes colors within a range within which colors appear as the same color to humans. For example, the determined color scheme includes colors whose spatial distance ΔE to the determined color scheme within the CIEL*a*b* color space is 2.0 or less. A different threshold value may be employed as long as it is a range within which colors appear as the same color to humans. Also, with the sRGB color gamut, it may be impossible to represent the lightness and saturation of colors having the same lightness and saturation. In that case, the lightness and saturation of each new color scheme may be determined based on the relationship between the hue of the selected color scheme and the hue of the new color scheme. Details will now be described with reference to FIG. 11B. FIG. 11B illustrates a lightness-saturation plane at a given hue angle in the CIEL*a*b* color space, and a color gamut 1109 represents the sRGB color gamut. In a case where the selected color scheme is situated at the position of a color 1110, the color with the maximum saturation with the hue of the selected color scheme in the sRGB color gamut can be represented as a color 1111. Also, the color with the maximum saturation with the hue of the new color scheme in the sRGB color gamut is represented as a color 1112. A color 1113 represents an intermediate color (L*=50) on the gray axis (a*=0, b*=0) in the sRGB color gamut. An example of a method of determining the new color scheme (color 1114) will now be described using FIG. 11B. First, a method of determining its lightness will be described. In the determination method, the lightness is determined based on the ratio between the lightness difference between the colors 1113 and 1111 and the lightness difference between the colors 1113 and 1110. Specifically, the lightness is determined by the following equation (3), in which Ls is the lightness of the selected color scheme (color 1110), Lsh is the lightness of the color with the maximum saturation with the hue of the selected color scheme (color 1111), and Lnh is the lightness of the color with the maximum saturation with the hue of the new color scheme (color 1112).

$$Lightness of New Color Scheme = 50 + ( ( Ls - 50 ) * ( Lnh - 50 ) / ( Lsh - 50 ) ) . \qquad Equation ( 3 )$$

For example, in a case where the lightness of the color 1111 (Lsh) is 70, the lightness of the color 1110 (Ls) is 60, and the lightness of the color 1112 (Lnh) is 30, the lightness of the color 1114 of the new color scheme is 40.

Next, a method of determining the saturation will be described. In the determination method, the saturation is determined from the ratio between the saturations of the colors 1110 and 1111 and the saturation of the color 1112. Specifically, the saturation is determined by the following equation (4), in which Hs is the saturation of the selected color scheme (color 1110), Hsh is the saturation of the color with the maximum saturation with the hue of the selected color scheme (color 1111), and Snh is the saturation of the color with the maximum saturation with the hue of the new color scheme (color 1112).

$$Saturation of New Color Scheme = Snh * ( Hs / Hsh ) . \qquad Equation ( 4 )$$

For example, in a case where the saturation of the color 1111 (Hsh) is 80, the saturation of the color 1110 (Hs) is 50, and the saturation of the color 1112 (Snh) is 60, the saturation of the color 1114 is 37.5. Even in a case where the new color scheme has a hue without the same saturation and lightness, the lightness and saturation of the new color scheme can be determined by performing the above calculations. In the present embodiment, the above-determined new color scheme includes colors within a predetermined range within which colors appear as the same color to humans. The predetermined ranges mean that the spatial distance ΔE within the CIEL*a*b* color space is 2.0 or less, for example. A different threshold value may be employed as long as it is a range within which colors appear as the same color to humans.

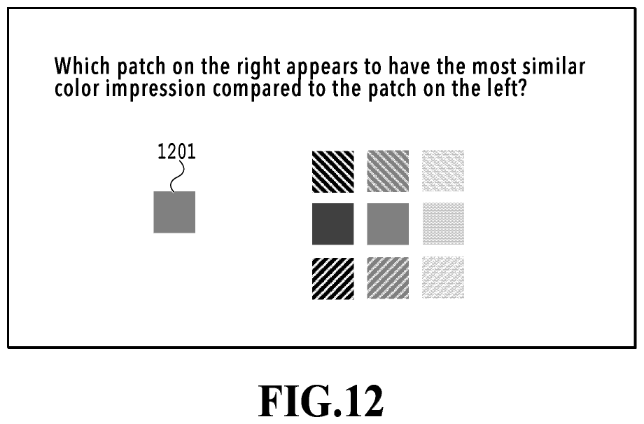

More preferably, a human subjective evaluation may be performed in advance on a hue-by-hue basis to determine saturations and lightnesses which form colors that give the same impression. A method for the subjective evaluation will now be described using FIG. 12. FIG. 12 illustrates a subjective evaluation in which the user selects a color that gives the same impression as a color 1201 from among the 3×3 patches on the right. Of the 3×3 patches, the center patch has lightness and saturation calculated by the above equation. The nine patches include the center patch and other patches with lightnesses of +5 and −5 and saturations of +5 and −5 from the center patch. As a specific example of the subjective evaluation, there is an example in which subjective evaluation is performed for each of 12 hue wheels for a total of 144 colors obtained by combining 12 colors having hue angles different from that of the color 1201 and 12 tones of lightnesses and saturations represented by the PCCS tone map. Here, PCCS stands for “Practical Color Co-ordinate System.” In this way, the subjective evaluation allows the above-described lightnesses and saturations to be determined to be lightnesses and saturations that appear the same to humans. Accordingly, the color of a new color scheme that appears natural to the human eye can be determined.

In S925, the color scheme pattern obtaining unit 215 determines whether a new color scheme has been determined for all of the color scheme patterns in the color scheme list passed to S922. In a case where a new color scheme has been determined for all of the color scheme patterns, the processing proceeds to S926. In a case where a new color scheme has not been determined for all of the color scheme patterns, the processing returns to S922.

In S926, color scheme patterns are obtained with colors in the list of determined new color schemes (FIG. 10D). In a case where the new color scheme list includes identical colors, they are merged into a single unique color. The color scheme patterns are based on a color scheme pattern extracted from a key design. One color in a color scheme pattern in the list of color schemes extracted from key designs (FIG. 10C) is replaced with colors stored in the new color scheme list (FIG. 10D), and new color scheme patterns thus generated are stored in the color scheme pattern list. In this way, color scheme patterns with different hues from the key colors can be obtained. FIG. 4 illustrates a list of color scheme patterns obtained in S926. The color scheme pattern obtaining unit 215 holds the RGB values of the plural colors in the RAM 103 in a table format. In FIG. 4, a color scheme pattern extracted from a key design is obtained from the color scheme list (FIG. 10C). Specifically, the color scheme pattern is the colors having “Key Design 1” as their source data in FIG. 10C. In FIG. 10C, they are the four colors with RGB values of (255, 228, 1), (223, 133, 67), (213, 151, 206), and (169, 241, 223). In S926, one of these four colors is replaced. In FIG. 4, the color with an RGB value of (255, 228, 1) is replaced with the new color scheme list (FIG. 10D). Specifically, the color with an RGB value of (255, 228, 1) is replaced with the four colors with RGB values of (71, 59, 133), (157, 109, 121), (122, 43, 122), and (1, 80, 157). This means that four color scheme patterns are newly obtained. Also, in addition to replacing the first color, the other colors included in the color scheme pattern may be changed according to the new color scheme. Specifically, the hue angles of the other colors than the color to be replaced may be changed according to the difference in hue angle between the color to be replaced and the new color scheme. An example processing method will now be described using FIG. 11C. FIG. 11C illustrates a color wheel as described in FIG. 11A. FIG. 11C illustrates a case where the color scheme pattern of a key design is colors 1115 to 1118, and a new color scheme is a color 1119. In this case, the color 1115 is changed to the color 1119. In response to this, the hue angles of the colors 1116 to 1118 are changed accordingly. Specifically, since the color 1115 is changed to the color 1119, which is the next hue in the clockwise direction, the hue angles of the other colors are changed to the next respective hue angles as well. In FIG. 11C, the color 1116 is changed to a color 1120, the color 1117 is changed to a color 1121, and the color 1118 is changed to a color 1122. The changed color scheme pattern is the colors 1119 to 1122, and is stored in the color scheme pattern list. The method of replacing only one color and the method of additionally replacing the other colors may be executed simultaneously. In the example described above, the color wheel is rotated clockwise, but may be rotated counterclockwise. Also, a method involving shifting the rotational angle by a predetermined angle may be employed. Specifically, the predetermined angle may be 30 degrees or 60 degrees. In this way, the number of types of new color scheme patterns can be increased.

Further, color scheme patterns in a group of preferred color scheme patterns stored in advance may be added according to the new color scheme and the color scheme pattern of the key design. In a case where the group of color scheme patterns stored in advance includes a color scheme pattern having the same colors as both the new color scheme and at least one color in the color scheme pattern of the key design, that color scheme pattern is stored as a new color scheme pattern in the color scheme pattern list (FIG. 4). In this way, a wider variety of commercial materials can be generated. Also, in a case where there is no color scheme pattern from a key design, a color scheme pattern in the group of preferred color scheme patterns stored in advance may be added according to the new color scheme. In this way, commercial materials can be generated even in a case where no key design is designated. Also, a method involving adding a color may be employed. In that case, the number of colors included per color scheme pattern is increased. For example, one color is added to the color scheme pattern table in FIG. 4 to create “Color 5”.

While a method of changing a color scheme pattern by selecting one color from the new color scheme list has been described above, two or more colors may be replaced. In the case of replacing two or more colors, the colors in the color scheme pattern extracted from the key design that are not to be replaced are determined. Then, based on the relationship in hue with one color among the colors not to be replaced, a color in the new color scheme list (FIG. 10D) that has an optimal hue angle in relation to that one color is selected. Specifically, a process similar to S923 is performed on one color among the colors not to be replaced to obtain the hue angles of the complementary color, contrasting colors, and similar colors. From the new color scheme list (FIG. 10D), as many colors as the number of colors to be replaced are selected which have the closest hue angles to the obtained hue angles. The colors to be replaced are replaced with the selected colors. The color scheme pattern after the replacement is stored in the color scheme pattern table in FIG. 4. In this way, a color scheme pattern with two or more colors replaced can be generated. This concludes the description of the process of S907. The description now returns to FIG. 9A.

In S908, the skeleton obtaining unit 213 obtains skeletons matching various setting conditions for each processing target commercial material type. In the present embodiment, each single skeleton is written in one file and saved in the HDD 104. The skeleton obtaining unit 213 sequentially reads out the skeleton files in the HDD 104 into the RAM 103, leave the skeletons matching the setting conditions in the RAM 103, and deletes the skeletons not matching the conditions from the RAM 103. Here, FIG. 9C is a flowchart illustrating the condition determination process performed by the skeleton obtaining unit 213. The condition determination process by the skeleton obtaining unit 213 will now be described in detail using FIG. 9C. The processes of S931 to S937 are a subflow for S908.

In S931 in FIG. 9C, the skeleton obtaining unit 213 determines, for each skeleton loaded to the RAM 103, whether a size set in advance for the processing target commercial material type and the size of the skeleton match each other. In FIGS. 5A and 5B, “Poster” is A2, “Postcard” is 100 mm×148 mm, and “Banner” is 360 mm×45 mm. Incidentally, while whether the sizes match each other is checked in this step, only whether the aspect ratios match each other may be checked. In that case, the skeleton obtaining unit 213 enlarges or reduces the coordinate systems of each loaded skeleton and obtains the skeletons matching the size of the processing target commercial material type.

In S932, the skeleton obtaining unit 213 determines, for each of the resulting skeletons, whether the purpose category set by the creation condition designation unit 201 and the category of the skeleton match each other. For skeletons to be used for particular purposes, their purpose categories are written in their skeleton files, and these skeletons are kept from being obtained unless their purpose categories are selected. In this way, in a case where a skeleton is designed specifically for a particular purpose, e.g., in a case where a design representing a school is depicted or a design of a sports product is depicted, the skeleton is prevented from being used for other purpose categories. Note that the process of S932 is skipped in a case where no purpose category is set on the app launch screen 501.

In S933, the skeleton obtaining unit 213 determines, for each loaded skeleton, whether the number of image objects therein and the number of images obtained by the image obtaining unit 211 match each other. In S934, the skeleton obtaining unit 213 determines, for each loaded skeleton, whether the character objects therein and the character information designated by the text designation unit 202 match each other. Specifically, the skeleton obtaining unit 213 determines whether the skeleton includes the types of character information designated by the text designation unit 202. For example, assume that character strings have been designated in the title box 502 and the main text box 504 on the app launch screen 501, and a blank has been designated in the subtitle box 503. In this case, the skeleton obtaining unit 213 searches for all character objects in the skeleton, and determines that the character objects in the skeleton and the character information designated by the text designation unit 202 match each other if finding both a character object with “Title” and a character object with “Main Text” as character information type in the metadata and, otherwise, determines that the character objects and the character information do not match each other.

In S935, the skeleton obtaining unit 213 determines, for each loaded skeleton, whether a graphic object is present therein. In a case where the creation condition designation unit 201 has designated a pattern, a graphic object for depicting the pattern needs to be present. The skeleton obtaining unit 213 skips the process of S935 in a case where the creation condition designation unit 201 has designated no pattern. In S936, the skeleton obtaining unit 213 determines, for each loaded skeleton, whether a logo object is present therein. In a case where the creation condition designation unit 201 has designated a logo, an object for depicting the logo needs to be present. The skeleton obtaining unit 213 skips the process of S936 in a case where the creation condition designation unit 201 has designated no logo. In S937, there are skeletons remaining in the RAM 103 which have passed all of the determination processes executed in S931 to S936. The skeleton obtaining unit 213 selects the skeletons remaining in the RAM 103 as skeletons to be used to generate the posters.

The skeleton obtaining unit 213 holds, in the RAM 103, the skeletons whose skeleton size, purpose category, number of image objects, types of character objects, number of graphic objects, and number of logo objects all match the setting conditions. Note that, in the present embodiment, the skeleton obtaining unit 213 makes the determinations on all skeleton files in the HDD 104, but the present embodiment is not limited to this. For example, the poster creation application may hold a database in which the file paths of skeleton files and search criteria are associated in the HDD 104 in advance. In that case, the skeleton obtaining unit 213 can search the database and load only matching skeleton files from the HDD 104 to the RAM 103. In this way, skeleton files are quickly obtained. Incidentally, the search criteria are, for example, the skeleton size, the number of image objects, the types of character objects, the number of graphic objects, and the number of logo objects. This concludes the description of the process of S908. The description now returns to FIG. 9A.

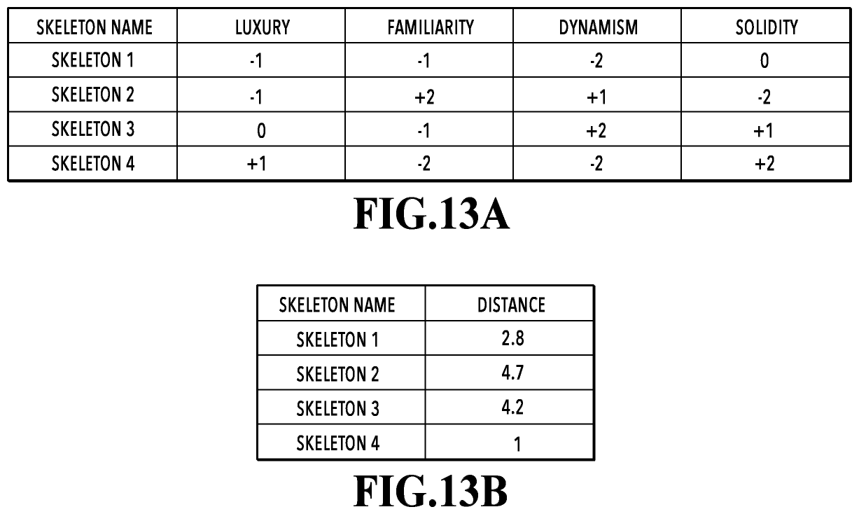

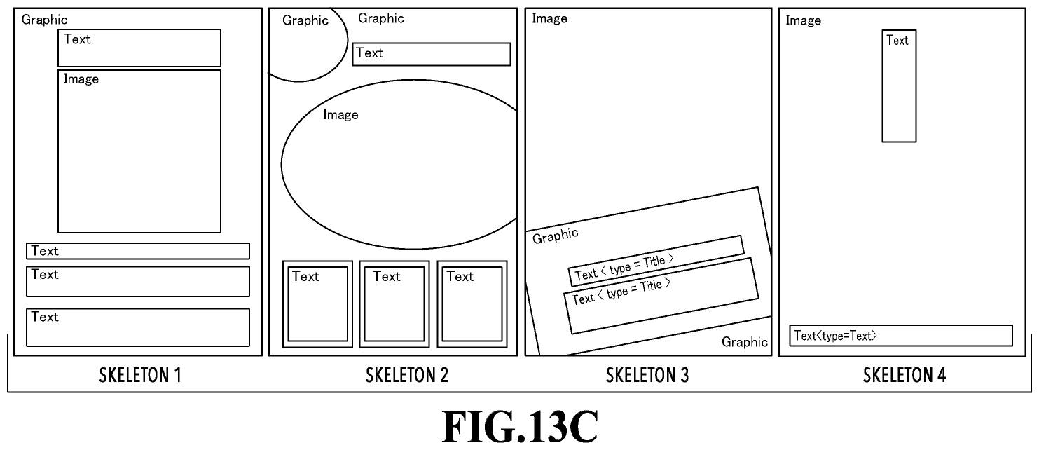

In S909, the skeleton selection unit 216 selects one or more skeletons matching the target impression designated by the design element designation unit 204 from among the skeletons obtained in S908. Here, FIGS. 13A to 13C are diagrams for describing a method by which the skeleton selection unit 216 selects skeletons for posters as an example. The skeleton selection unit 216 executes similar processes for the other commercial material types. FIG. 13A is a diagram illustrating an example of a table in which skeletons and impressions are linked. In FIG. 13A, the “Skeleton Name” column lists file names of skeletons, while the “Luxury,” “Familiarity,” “Dynamism,” and “Solidity” columns each list numbers (numerical values) indicating the extents to which the respective skeletons impact the impression. These numerical values are values representing the impression such that −2 is low, −1 is somewhat low, 0 is neither low nor high, +1 is somewhat high, and +2 is high. First, the skeleton selection unit 216 calculates the distance between the target impression obtained from the design element designation unit 204 and the set of impressions of each skeleton listed in the skeleton impression table in FIG. 13A. For example, in a case where the target impression is “Luxury: +1, Familiarity: −1, Dynamism: −2, Solidity: +2,” the skeleton selection unit 216 calculates the distance as illustrated in FIG. 13B. Note that the present embodiment uses the Euclidean distance as the distance (hereinafter, in a case where the term “distance” is simply used, it means “Euclidean distance”). A smaller value of the Euclidean distance indicates a closer resemblance between the target impression and the skeleton's impression. The skeleton selection unit 216 then selects the top N skeletons with the shortest distances in FIG. 13B. In the present embodiment, the skeleton selection unit 216 selects the top two skeletons. Specifically, the skeleton selection unit 216 selects Skeletons 1 and 4. Here, “N” may be set by any method as long as it is an integer of 1 or more.

Also, the value range of the impressions in the skeleton impression table in FIG. 13A does not need to be the same value range of the impressions designated by the design element designation unit 204. In the present embodiment, the value range of the impressions designated by the design element designation unit 204 is from −2 to +2, but the value range of the impressions in the skeleton impression table may be different from this. In that case, the above-described distance is calculated after the value range in the skeleton impression table is scaled to match the value range of the target impression values. Also, the distance to be calculated by the skeleton selection unit 216 is not limited to the Euclidean distance, and the skeleton selection unit 216 only needs to be able to calculate a distance between vectors, such as the Manhattan distance or cosine similarity. Also, any impressions in the target impression whose design element information radio buttons 523 are turned off are excluded from the distance calculation.

Note that the skeleton impression table is created in advance by, for example, generating poster images based on the skeletons with the same color scheme pattern, font, and image and character data to be arranged in the skeletons, and estimating their impressions. The skeleton impression table created in advance is saved in the HDD 104. That is, the impression of each poster image using the same character color, image, and the like but having a different arrangement of the characters, the image, or the like is estimated to form a table of comparative characteristics to the other skeletons'. In doing so, it is desirable to perform a process of standardizing the estimated impressions as a whole, a process of averaging the impressions of plural poster images generated from a single skeleton with plural color scheme patterns or images, a process of canceling impressions originating from the used color scheme patterns, images, or the like, and so on. In this way, for example, the impressions of skeletons with small images are determined based on elements such as their graphics or characters instead of their images, and thus effects of the layouts on the impressions, such as, arranging an image or characters at an angle gives a strong sense of dynamism, can be organized in the form of a table. FIG. 13C is an example of skeletons corresponding to Skeletons 1 to 4 in FIG. 13A. For example, in Skeleton 1, an image object and character objects are arranged in an orderly manner and also the area of the image is small, which gives a low sense of dynamism. In Skeleton 2, a figure object and the image object are circular, which gives a high sense of familiarity and a low sense of solidity. In Skeleton 3, the image object is arranged over a large area and additionally the figure object is arranged at an angle on the image object, which gives a high sense of dynamism. In Skeleton 4, the image is arranged over the entire skeleton and the character objects are reduced to minimum character objects, which gives a high sense of solidity and a low sense of dynamism. As described above, in a case where poster images include characters or images, varying the arrangement of the characters or the images generates poster images with different target impressions. Note that the method of creating the skeleton impression table is not limited to the above. A skeleton impression table may be estimated from features in layout information such as the areas or coordinates of the images and the title character string. Alternatively, the skeleton impression table may be adjusted by user operations. The skeleton impression table is saved in the HDD 104, and the skeleton selection unit 216 reads the skeleton impression table out of the HDD 104 into the RAM 103 and refers to it.

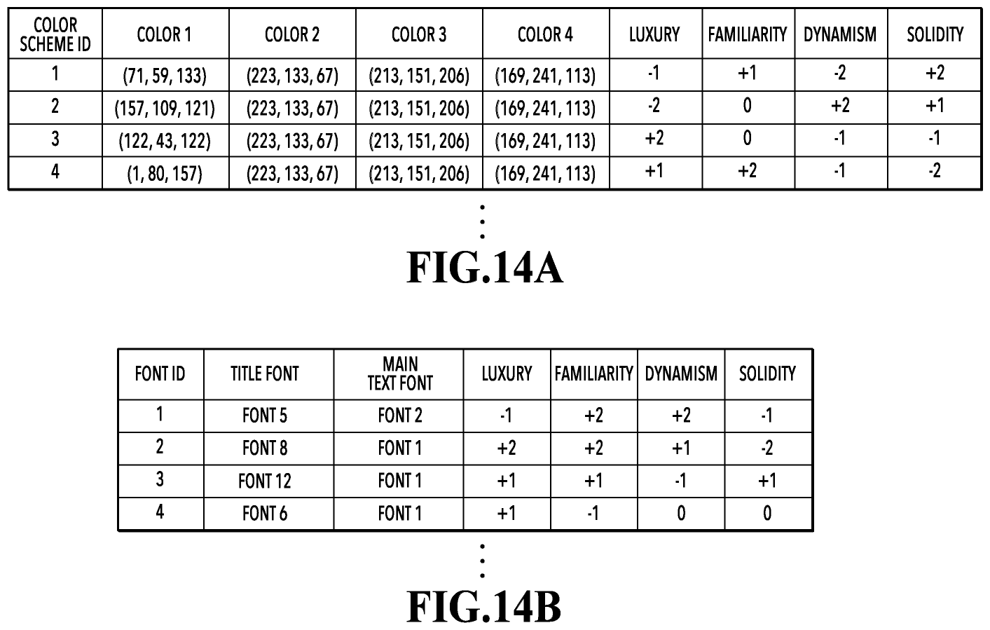

In S910, the color scheme pattern selection unit 217 selects color scheme patterns matching the target impression designated by the design element designation unit 204 from among the color scheme patterns obtained in S907. The method of selecting color scheme patterns matching the target impression is similar to the method for the process of S909, in which the color scheme pattern selection unit 217 refers to an impression table for color scheme patterns and selects color scheme patterns according to the target impression. FIG. 14A illustrates an example of a color scheme pattern impression table in which color scheme patterns and impressions are linked. The color scheme pattern selection unit 217 calculates the values of the distances between the values of the sets of impressions listed in the “Luxury” to “Solidity” columns in FIG. 14A and the value of the target impression, and selects the top N color scheme patterns with the smallest distance values. In the present embodiment, the color scheme pattern selection unit 217 selects the top two color scheme patterns. Note that the color scheme pattern impression table is like the skeleton impression table; by creating posters by using different color scheme patterns and maintaining the same elements other than the color scheme pattern such as the skeleton, font, and images, the tendency of the impressions of the color scheme patterns can be organized into the form of a table. In a method in which color scheme patterns matching the designated colors are selected, colors close to colors included in the color scheme patterns are selected. For example, in a case where colors whose distance ΔE within the CIEL*a*b* color space is 2.0 or less is included, the colors whose distance ΔE is 2.0 or less are selected. A distance ΔRGB of 1.0 or less within an RGB color space may be another determination criterion. Specifically, in a case where the designated color is (R, G, B)=(0, 67, 69), the distance ΔRGB of “Color 1” of “Color Scheme ID 1” in FIG. 14A is 1.0 or less, so that this “Color Scheme ID 1” is selected.

In S911, the pattern selection unit 218 selects a combination of patterns matching the target impression from the pattern list obtained by the design element obtaining unit 214. The method of selecting a combination of patterns matching the target impression is similar to the method in S909, in which the pattern selection unit 218 refers to an impression table for patterns and selects patterns according to the target impression.

In S912, the logo selection unit 219 selects a combination of logos matching the target impression from the logo list obtained by the design element obtaining unit 214. The method of selecting a combination of logos matching the target impression is similar to the method in S909, in which the logo selection unit 219 refers to an impression table for logos and selects logos according to the target impression. Additionally, in S912, the font selection unit 220 selects a combination of fonts matching the target impression designated by the design element obtaining unit 214. The method of selecting a combination of fonts matching the target impression is similar to the method in S909, in which the font selection unit 220 refers to an impression table for fonts and selects fonts according to the target impression. FIG. 14B illustrates an example of the font impression table, in which fonts and impressions are linked. The font selection unit 220 calculates the distances between the values of the sets of impressions listed in the “Luxury” to “Solidity” columns in FIG. 14B and the value of the target impression, and selects the top N fonts with the smallest distance values. Note that the font impression table is like the skeleton impression table; by creating posters by using different fonts and maintaining the same elements other than the font such as the skeleton, color scheme pattern, and images, the tendency of the impressions of the color scheme patterns can be organized into the form of a table. In a method in which a combination of fonts matching the designated font is selected, a combination of fonts including the designated font is selected. Further, a combination of fonts whose impression values are close to those of the fonts in the combination of fonts including the designated font may be additionally selected. In this way, it is possible to select a font whose impression is close to that of the designated font.

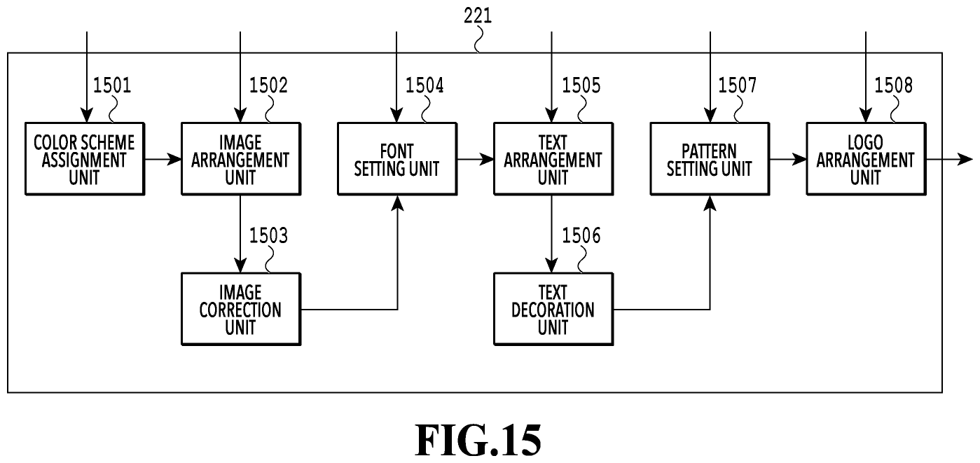

In S913, the layout unit 221 sets character information, images, a color scheme, a font, a pattern, and a logo on each skeleton selected by the skeleton selection unit 216 to generate a poster. The process of S913 and the processing by the layout unit 221 will now be specifically described using FIGS. 15, 16, 17A to 17C, and 18A to 18D.

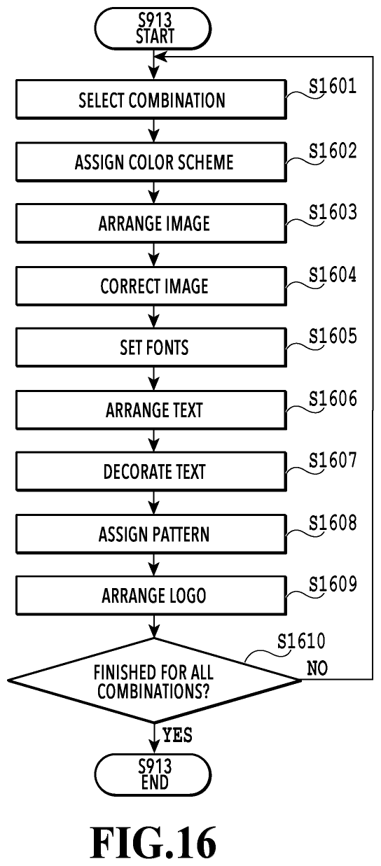

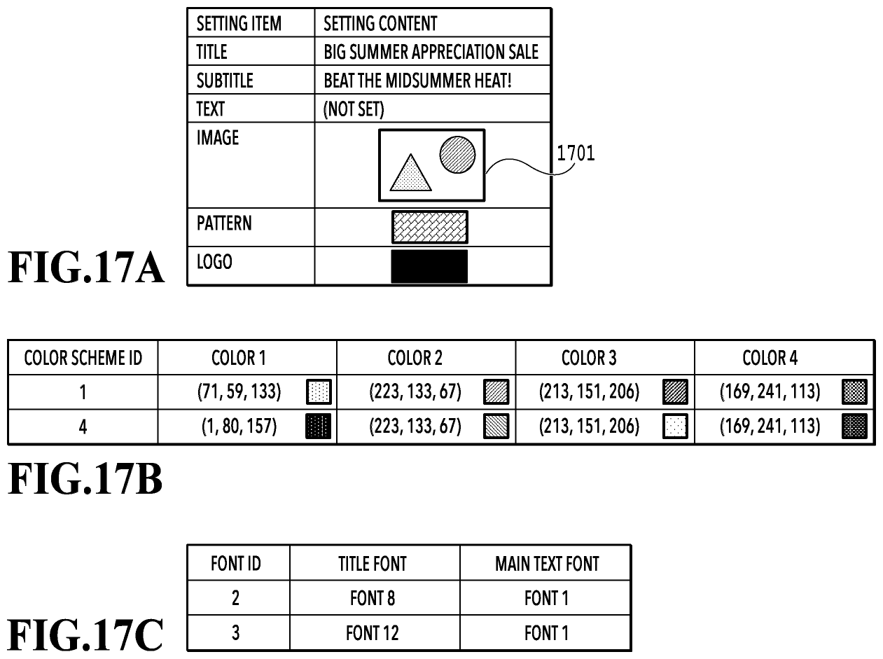

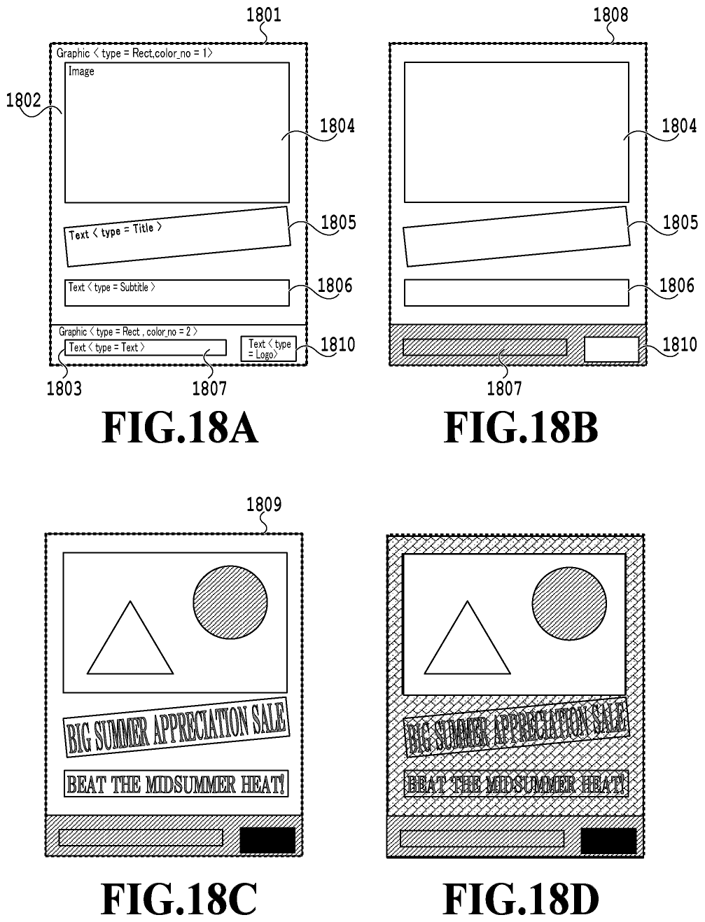

FIG. 15 is an example software block diagram describing the layout unit 221 in detail. The layout unit 221 includes a color scheme assignment unit 1501, an image arrangement unit 1502, an image correction unit 1503, a font setting unit 1504, a text arrangement unit 1505, a text decoration unit 1506, a pattern setting unit 1507, and a logo arrangement unit 1508. FIG. 16 is a flowchart for describing the process of S913 in detail. Also, FIGS. 17A to 17C are diagrams describing information to be input into the layout unit 221. FIG. 17A is a table in which the character information designated by the text designation unit 202 and the images designated by the image designation unit 203 are organized. FIG. 17B is an example of a table illustrating the color scheme patterns obtained from the color scheme pattern selection unit 217. FIG. 17C is an example of a table illustrating the fonts obtained from the font selection unit 220. FIGS. 18A to 18D are diagrams describing the progression of the processing by the layout unit 221.

Details of the process of S913 will now be described using FIG. 16. Specifically, the processes of S1601 to S1610 are a subflow for S913. In S1601, the layout unit 221 lists all combinations of the skeletons obtained from the skeleton selection unit 216, the color scheme patterns obtained from the color scheme pattern selection unit 217, and the fonts obtained from the font selection unit 220. The layout unit 221 performs the following layout process sequentially on each of the combinations to generate poster data. For example, in a case where the number of skeletons obtained from the skeleton selection unit 216 is three, the number of color scheme patterns obtained from the color scheme pattern selection unit 217 is two, and the number of fonts obtained from the font selection unit 220 is two, the layout unit 221 generates 3×2×2=12 pieces of poster data. Then, in S1601, the layout unit 221 selects one combination from among the listed combinations and executes the processes of S1602 to S1609 on it.

In S1602, the color scheme assignment unit 1501 assigns the color scheme pattern obtained from the color scheme pattern selection unit 217 to the skeleton obtained from the skeleton selection unit 216. FIG. 18A is a diagram illustrating an example of the skeleton. In the present embodiment, an example of assigning the color scheme pattern with the color scheme ID “1” in FIG. 17B to a skeleton 1801 in FIG. 18A will be described. The skeleton 1801 in FIG. 18A includes two figure objects 1802 and 1803, one image object 1804, and three character objects 1805, 1806 and 1807. First, the color scheme assignment unit 1501 arranges colors on the figure objects 1802 and 1803. Specifically, based on the color scheme numbers being metadata written in the figure objects, the color scheme assignment unit 1501 assigns corresponding colors in the color scheme pattern. Then, the color scheme assignment unit 1501 assigns, for example, the last color in the color scheme pattern to the character object whose metadata represents a type with an attribute “Title”. That is, in the present embodiment, the color scheme assignment unit 1501 assigns “Color 4” to the characters to be arranged on the character object 1805. Then, the color scheme assignment unit 1501 sets the character colors of the characters to be arranged on the character objects other than the character object whose metadata represents the type with the attribute “Title” based on the lightnesses of the backgrounds of these character objects. In the present embodiment, in a case where the lightnesses of the backgrounds of the above character objects are less than or equal to a threshold value, their character colors are set to white. In a case where the lightnesses of the backgrounds of the above character objects are more than the threshold value, their character colors are set to black. FIG. 18B is a diagram illustrating the state of a skeleton 1808 subjected to the above color scheme assignment process. The color scheme assignment unit 1501 outputs skeleton data after the color arrangement to the image arrangement unit 1502.

In S1603, the image arrangement unit 1502 arranges the image data obtained from the image analysis unit 212 on the skeleton data obtained from the color scheme assignment unit 1501 based on analysis information attached to the image data. In the present embodiment, the image arrangement unit 1502 assigns image data 1701 to the image object 1804 in the skeleton. Also, in a case where the image object 1804 and the image data 1701 have different aspect ratios, the image arrangement unit 1502 trims the image data 1701 such that its aspect ratio matches the aspect ratio of the image object 1804. More specifically, based on the position of the object obtained by the image analysis unit 212 through an analysis on the image data 1701, the image arrangement unit 1502 performs the trimming so as to minimize the object's region to be reduced by the trimming. Note that the trimming method is not limited to this, and another trimming method may be used, such as cropping a center portion of the image or adjusting the composition such that the position of a face forms a triangular composition, for example. The image arrangement unit 1502 outputs the skeleton data after the image assignment to the image correction unit 1503.

In S1604, the image correction unit 1503 obtains the skeleton data after the image assignment from the image arrangement unit 1502 and performs a correction on each image arranged in the skeleton. In the present embodiment, the image correction unit 1503 performs an upsampling process by super-resolution processing in a case where the resolution of the image is insufficient. First, the image correction unit 1503 determines whether the image to be arranged in the skeleton has a certain resolution. Assume, for example, that a 1600 (px)×1200 (px) image is assigned to a 200 (mm)×150 (mm) region in the skeleton. In this case, the print resolution of the image can be calculated by Equation (5).

$$1600 / ( ( 200 / 25.4 ) ) \approx 203 [ dpi ] . \qquad Equation ( 5 )$$

Then, in a case where determining that the print resolution of the image is less than a threshold value, the image correction unit 1503 raises the resolution by super-resolution processing. On the other hand, in a case where the determining that print resolution of the image is more than or equal to the threshold value and the image has a sufficient resolution, the image correction unit 1503 performs no image correction. In the present embodiment, the image correction unit 1503 performs the super-resolution processing in a case where the print resolution of the image is less than 300 dpi.

In S1605, the font setting unit 1504 sets the fonts obtained from the font selection unit 220 for the skeleton data after the image correction obtained from the image correction unit 1503. FIG. 17C is an example of the combination of fonts selected by the font selection unit 220. The present embodiment will describe an example of assigning fonts to the skeleton data after the image correction in a case where the fonts to be assigned are the ones with the font ID “2” in FIG. 17C. In the present embodiment, fonts are set for the character objects 1805, 1806 and 1807 in the skeleton 1808. Note that posters tend to employ eye-catching fonts for titles from the perspective of attracting attention and to employ easy-to-read fonts for other characters from the perspective of readability. For this reason, in the present embodiment, the font selection unit 220 selects two types of fonts, namely, a title font and a main text font. The font setting unit 1504 sets the title font for the character object 1805, whose attribute is “Title”. The font setting unit 1504 sets the main text font for the other character objects 1806 and 1807. The font setting unit 1504 outputs the skeleton data after the setting of the fonts to the text arrangement unit 1505. Note that, in the present embodiment, the font selection unit 1504 selects two types of fonts, but the present embodiment is not limited to this and the font selection unit 1504 may select only the title font, for example. In that case, the font setting unit 1504 uses a font corresponding to the title font as the main text font. Specifically, in a case of using a Gothic font for the title, the font setting unit 1504 selects a representative Gothic font with high readability for the character objects other than the title. In a case of using a Mincho font for the title, the font setting unit 1504 selects a representative Mincho font for the character objects other than the title and sets a main text font matching the type of the title font. The font setting unit 1504 may use the same font for the title and the main text, as a matter of course. Also, the font setting unit 1504 may use the title font for the title and the subtitle and use the main text font for the other character object. The font setting unit 1504 may use different fonts for different character objects according the degrees to which the objects are planned to stand out, e.g., using the title font for character objects whose font sizes are more than or equal to a predetermined value.

In S1606, the text arrangement unit 1505 arranges the text designated by the text designation unit 202 in the skeleton data after the setting of the fonts obtained from the font setting unit 1504. In the present embodiment, the text arrangement unit 1505 refers to the attribute in the metadata of each character object in the skeleton and assigns the pieces of text illustrated in FIG. 17A. Specifically, the text arrangement unit 1505 assigns “BIG SUMMER APPRECIATION SALE” corresponding to the attribute “Title” to the character object 1805, and assigns “BEAT THE MIDSUMMER HEAT!” corresponding to the attribute “Subtitle” to the character object 1806. The text arrangement unit 1505 assigns nothing to the character object 1807 since no main text is set. FIG. 18C illustrates a skeleton 1809 as an example of the skeleton data processed by the text arrangement unit 1505. The text arrangement unit 1505 outputs the skeleton data after the text arrangement to the text decoration unit 1506.

In S1607, the text decoration unit 1506 decorates one or more character objects in the skeleton after the text arrangement obtained from the text arrangement unit 1505. In the present embodiment, the text decoration unit 1506 performs a process of outlining the title characters in a case where the color difference between the title characters and their background region is less than or equal to a threshold value. This improves the readability of the title. The text decoration unit 1506 outputs the decorated skeleton data to the pattern setting unit 1507.

In S1608, the pattern setting unit 1507 sets a pattern in a graphic object determined to be a background region in the skeleton data after the text decoration obtained from the text decoration unit 1506. The graphic object determined to be a background region is a graphic object with the color scheme number “1”. In FIG. 18B, the pattern setting unit 1507 sets the pattern on the background region of the skeleton 1808. Setting the pattern involves changing the color to the color scheme assigned by the color scheme assignment unit 1501 and then setting the pattern on the background region. FIG. 18D illustrates an example of the set pattern. The pattern setting unit 1507 sets the pattern set in the skeleton data in a case where the creation condition designation unit 201 has set no pattern. The pattern setting unit 1507 outputs the skeleton data after the setting of the pattern to the logo arrangement unit 1508.

In S1609, the logo arrangement unit 1508 arranges a logo on the logo object in the skeleton data after the setting of the pattern obtained from the pattern setting unit 1507. FIG. 18D illustrates an example of the arranged logo. S1609 is skipped in a case where the creation condition designation unit 201 has set no logo. The logo arrangement unit 1508 outputs the skeleton data after the arrangement of the logo, i.e., the commercial material data having undergone all steps in the layout process, to the impression estimation unit 222.

In S1610, the layout unit 221 determines whether all pieces of commercial material data have been generated. In a case where determining that pieces of commercial material data have been generated using all combinations of skeletons, color scheme patterns, and fonts, a pattern, and a logo for the processing target commercial material, the layout unit 221 terminates the layout process, and the processing proceeds to S911. In a case where it is determined that not all pieces of commercial material data have been generated, the processing returns to S1601, and a piece of commercial material data is generated using a combination with which a piece of commercial material data has not yet been generated. This concludes the description of S913. The description now returns to FIG. 9A.

In S914, the impression estimation unit 222 estimates impressions of the pieces of commercial material data generated in S913 and links them to the pieces to commercial material data. Specifically, the impression estimation unit 222 executes a rendering process on the pieces of commercial material data generated in S913. Then, the impression estimation unit 222 estimates impressions of the rendered pieces of commercial material data. Lastly, the impression estimation unit 222 links the estimated impressions to the respective pieces of commercial material data. Note that the rendering process refers to a process of converting the pieces of commercial material data into pieces of image data. In a case where, for example, pieces of commercial material data have the same color scheme pattern but use different skeletons, their layouts are different, and therefore the actual area of each color used can vary. For this reason, it is necessary to evaluate not only the tendency of the impressions of the individual color scheme patterns or skeletons but also the impressions of the final commercial materials. This is why the process executed with this timing. This makes it possible to evaluate not only impressions of individual elements of the commercial materials, such as their color schemes and layouts, but also impressions of the final commercial materials in which the images and the characters are arranged.

In S915, it is determined whether pieces of commercial material data have been generated for the number of commercial materials to be created per commercial material type determined in S905. In the present embodiment, the number of pieces of commercial material data is five. In a case where pieces of commercial material data have not been generated for the number of commercial materials to be created, the processing returns to S909, and pieces of commercial material data yet to be created are generated. In a case where pieces of commercial material data have been generated for the number of commercial materials to be created, the processing proceeds to S916.

In S916, it is determined whether pieces of commercial material data have been generated for all of the types of commercial materials to be created determined in S905. In the present embodiment, five pieces of commercial material data are generated for each of three commercial material types. That is, 15 pieces of commercial material data are generated. In a case where pieces of commercial material data have not been generated for the number of commercial materials to be created for all commercial material types, the target commercial material type is changed, the processing returns to S908, and pieces of commercial material data are generated for the number of commercial materials to be created for the newly set commercial material type. In a case where pieces of commercial material data have been generated for the number of commercial materials to be created for all commercial material types, the generation process is terminated, and the processing proceeds to S917.

In S917, the commercial material selection unit 223 selects one or more commercial material sets to be output to the display 105 (to be presented to the user) based on the estimated impressions obtained from the impression estimation unit 222. Specifically, firstly, the commercial material selection unit 223 calculates an impression distance between each of the estimated impressions linked to the respective pieces of commercial material data (commercial material designs) and the target impression. The calculated impression distance is saved in association with the corresponding piece of commercial material data. In the present embodiment, 15 pieces of commercial material data have been generated, and therefore 15 impression distances are calculated. Euclidean distances are used as the impression distances. A smaller value of the Euclidean distance indicates a closer resemblance between the target impression and the estimated impression. Also, the distance to be calculated by the commercial material selection unit 223 is not limited to the Euclidean distance, and the commercial material selection unit 223 only needs to be able to calculate a distance between vectors, such as the Manhattan distance or cosine similarity. Then, the commercial material selection unit 223 calculates a total impression distance for each commercial material set. In the present embodiment, one commercial material set includes two commercial materials, namely a postcard and a banner. The commercial material selection unit 223 sums the two impression distances calculated for the respective commercial materials to calculate the total impression distance. The calculated total impression distance is saved in association with the commercial material set. Then, based on the total impression distances associated with the commercial material sets, the commercial material selection unit 223 selects one or more commercial material sets. In a case where one commercial material set is displayed, it means that the commercial material set with the shortest total impression distance is selected. Also, in the present embodiment, plural commercial material sets are displayed on the commercial material preview screen 601 in FIGS. 6A to 6F. Thus, as many commercial material sets with the shortest total impression distances as the number of commercial material sets to be displayed are selected. Also, the commercial material selection unit 223 may select the commercial material sets with a total impression distance that is less than or equal to a predetermined threshold value. In this case, in a case where the commercial material selection unit 223 fails to select as many commercial material sets as the number of commercial material sets to be displayed on the commercial material preview screen, the processing may return to S908 to generate different pieces of commercial material data.

In S918, the generated commercial material display control unit 206 displays the commercial material preview screen 601 in one of FIG. 6A to FIG. 6F on the display 105. Specifically, the generated commercial material display control unit 206 renders the plural pieces of commercial material data included in the commercial material sets selected by the commercial material selection unit 223 in S915, and outputs the rendered pieces of data to the display 105. This concludes the description of the flow of the poster generation process for generating posters based on impressions designated by the user.

As described above, according to the present embodiment, appropriate cohesive designs that represent an impression intended by the user can be generated by combining plural commercial materials. That is, appropriate cohesive designs can be generated from a commercial material group formed of the commercial materials created this time and the already created commercial materials designated as key designs. More specifically, in the present embodiment, in order to generate designs representing a brand's impression intended by a user, constituent elements of commercial materials, such as a skeleton, a color scheme pattern, and a font, are combined for each commercial material based on a target impression. Further, impressions of the whole commercial materials are estimated, based on which commercial materials close to the target impression are selected from among one or more candidate posters. In this way, it is possible to generate commercial materials whose impression as a whole, in addition to the impressions of the individual elements, matches the user's intention. Further, by obtaining color scheme patterns with different hues based on the color schemes of the key designs and combining plural commercial materials using the color scheme patterns, it is possible to generate appropriate commercial materials with cohesive designs.

### Modifications of First Embodiment

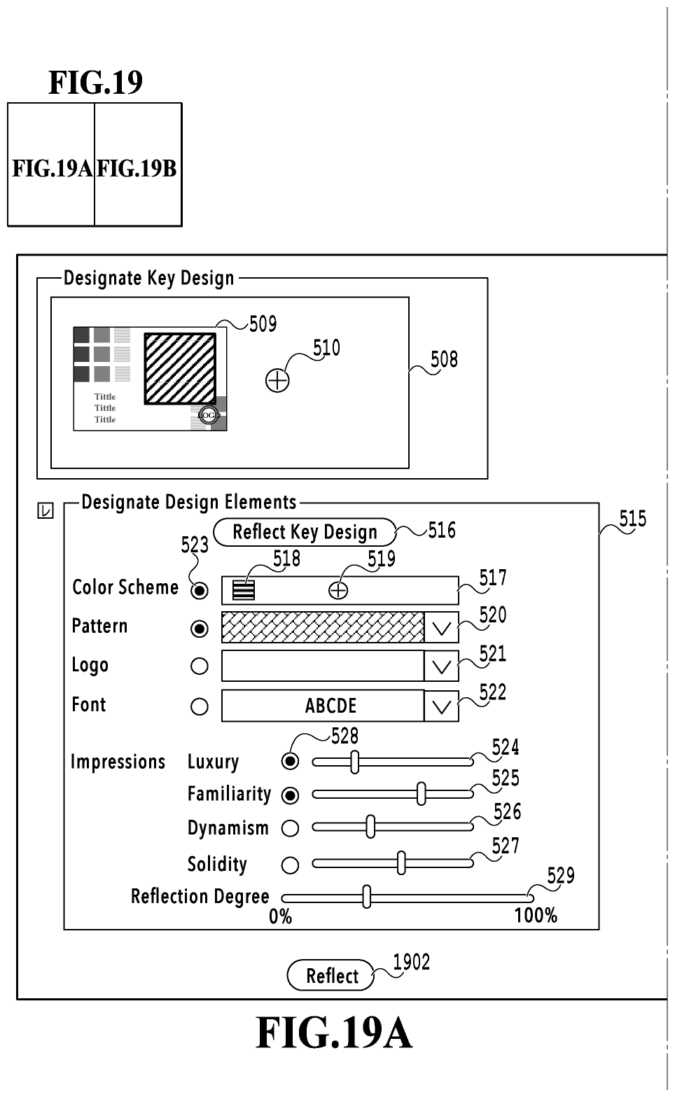

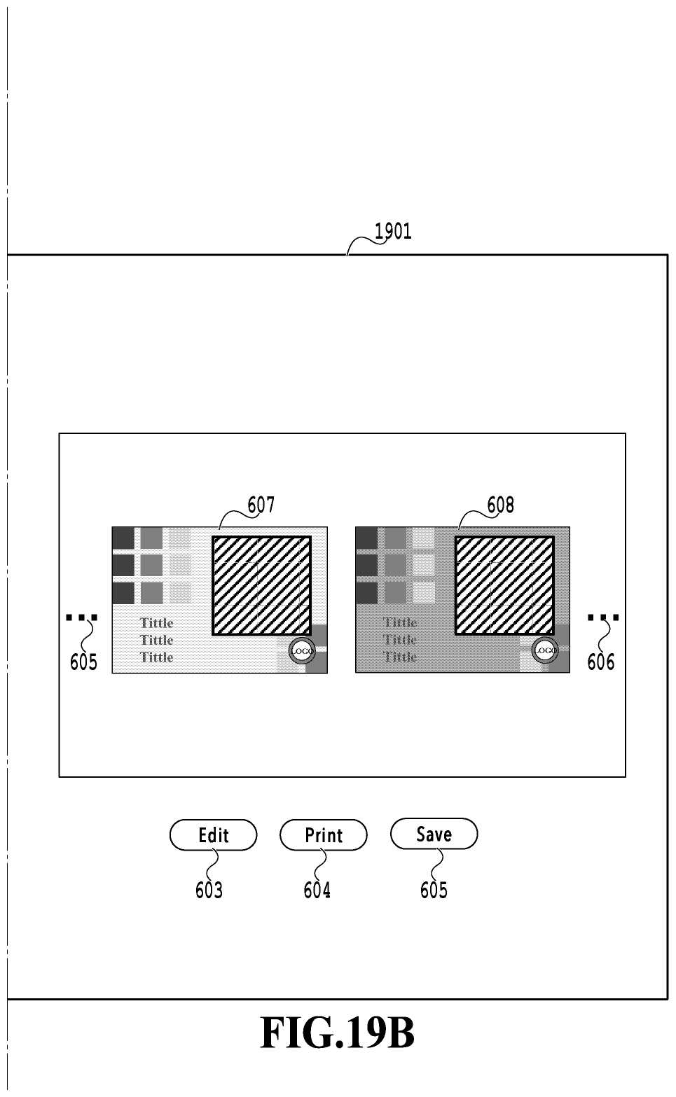

In the first embodiment, one or more generated commercial material sets are displayed on the commercial material preview screen 601. Here, the target impressions and the brand information may be set on the commercial material preview screen. FIGS. 19A and 19B are diagrams illustrating an example of a UI for setting key designs and design elements on a commercial material preview screen 1901. The components denoted by the same numbers as those in FIGS. 5A and 5B performs the operations set forth in the description of FIGS. 5A and 5B. The components denoted by the same numbers as those in FIGS. 6A to 6F perform the operations set forth in the description of FIGS. 6A to 6F. In S918, the generated commercial material display control unit 206 displays the commercial material preview screen 1901 on the display 105. On the commercial material preview screen 1901, the key design designation region 508 is arranged as a UI for setting key designs. In the design element designation region 515, the color scheme designation box 517, the pattern designation box 520, the logo designation box 521, the font designation box 522, and the reflection degree slider bar 529 are arranged as UI for setting design elements. Further, in the design element designation region 515, the impression sliders 524 to 527 and the impression radio buttons 528 of the app launch screen 501 are arranged as UI for setting target impressions.

On the commercial material preview screen 1901, a reflect button 1902 for reflecting the set information is arranged. While checking the commercial material images 607 and 608 displayed as a preview, the user changes the target impressions and the brand information. The user then presses the reflect button 1902. As a result, the processing proceeds to S902, and the processes of S902 to S918 are executed. As a result of executing the processes, the generated commercial material display control unit 206 displays, on the display 105, the preview of the commercial material images 607 and 608 in which the key design and the design elements set on the commercial material preview screen 1901 are reflected. In this way, it is possible to set key designs and design elements while checking the generated commercial material set. Accordingly, it is possible to generate plural appropriate commercial materials with cohesive designs by combining plural commercial materials while representing an impression intended by the user without troublesome screen transitions.

### Second Embodiment

The first embodiment has described an example in which commercial materials are generated with skeletons, color scheme patterns, and fonts selected based on a target impression as constituent elements of the commercial materials. In a second embodiment, a combination generation unit searches for combinations of constituent elements of commercial materials with which the impressions of the posters as a whole are close to a target impression based on a genetic algorithm. In this way, it is possible to flexibly generate appropriate commercial materials with commercial material constituent elements that are most suitable for the target impression without the preparatory calculations for the skeleton impression table, the color scheme pattern impression table, the font impression table, and the like. Further, by combining plural commercial materials, it is possible to generate plural appropriate commercial materials with cohesive designs. Note that, as in the first embodiment, the colors in the design of each commercial material to be generated include at least one color at a hue angle that is different from any of the colors in the color scheme included as a design element.

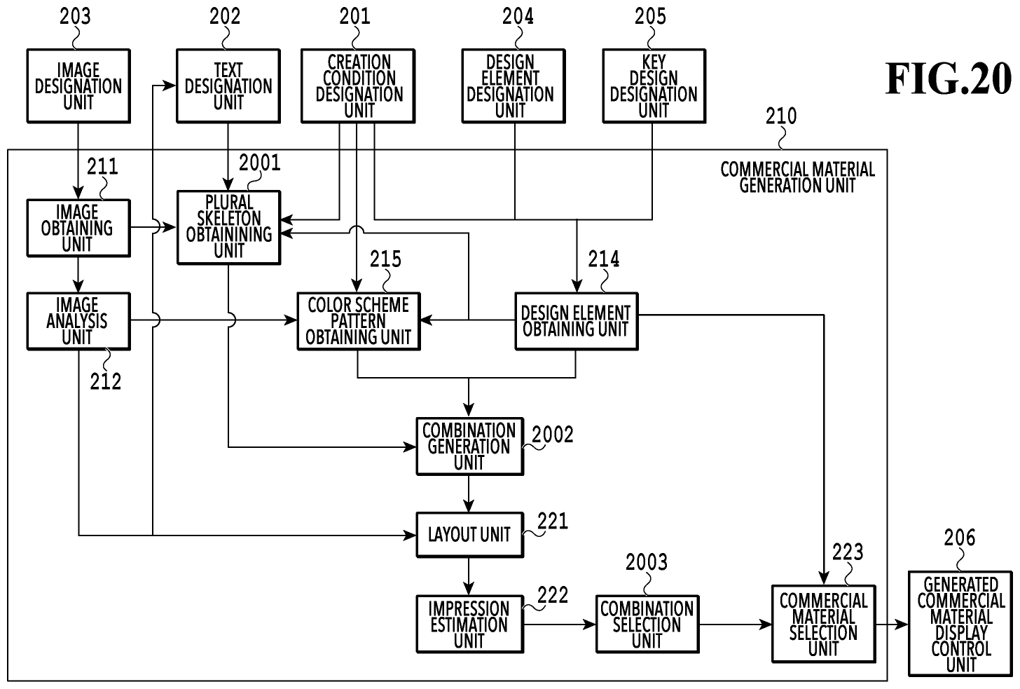

FIG. 20 is a software block diagram of a commercial material creation application in the present embodiment. The configuration in the block diagram illustrated in FIG. 20 includes a combination generation unit 2002 in place of the skeleton selection unit 216, the color scheme pattern selection unit 217, the pattern selection unit 218, the logo selection unit 219, and the font selection unit 220 in FIG. 2. Note that the components denoted by the same numbers as those in FIG. 2 perform similar processes to those described in the first embodiment, and description thereof is therefore omitted.

A plural skeleton obtaining unit 2001 obtains skeletons for the one or more commercial material types designated by the creation condition designation unit 201. Since a search algorithm will be used, the plural skeleton obtaining unit 2001 obtains all skeletons for the designated commercial material types and saves them to the RAM 103.

The combination generation unit 2002 obtains the one or more skeletons for each commercial material type from the plural skeleton obtaining unit 2001 and obtains pieces of commercial material data and estimated commercial material impressions from the impression estimation unit 222. The combination generation unit 2002 obtains a target impression from the design element obtaining unit 214. The combination generation unit 2002 obtains a color scheme pattern list, a font list, a pattern list, and a logo list from the HDD 104. Further, the combination generation unit 2002 generates combinations of commercial material constituent elements (skeleton, color scheme pattern, font) and design elements (logo, pattern) to be used to generate commercial materials for the commercial material types. In the present embodiment, the combination generation unit 2002 generates combinations for two commercial material types, namely postcard and banner, as one example. A single combination for these commercial material types is defined as a single commercial material set combination. The combination generation unit 2002 outputs the generated commercial material set combinations to the layout unit 221.

A combination selection unit 2003 selects combinations of commercial materials whose value of a distance between the estimated impression of the commercial material data obtained from the impression estimation unit 222 and the target impression obtained by the design element obtaining unit 214 is less than or equal to a threshold value, and saves them to the RAM 103. Also, the combination selection unit 2003 determines whether the number of selected and saved commercial materials has reached a designated number of commercial materials.

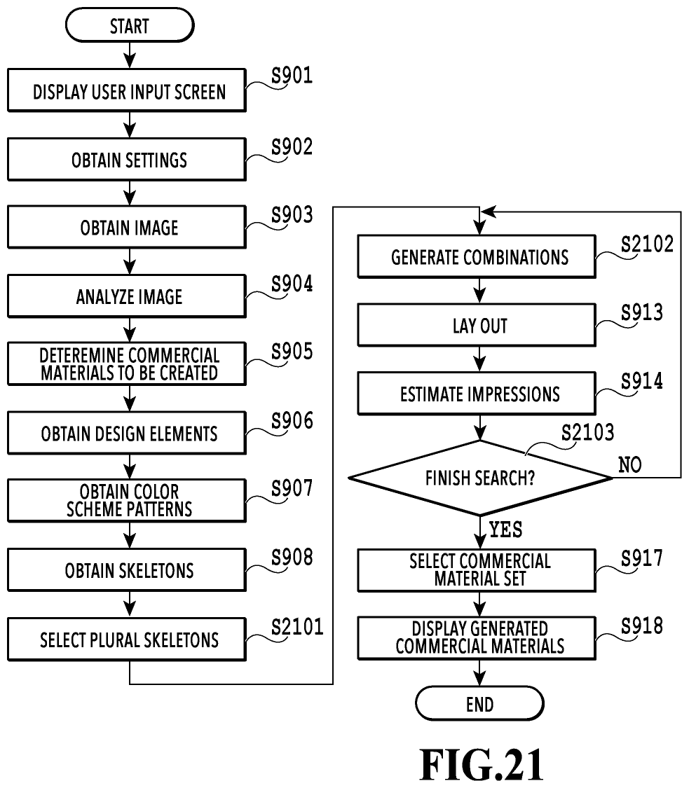

FIG. 21 is a flowchart illustrating processing by the commercial material generation unit 210 of the commercial material creation application in the present embodiment. Note that, in the processes in this flowchart denoted by the same numbers as those in the flowchart of FIG. 9A, the same processes as those described in the first embodiment are performed, and description thereof is therefore omitted. Note that, in this flowchart, the processes of S909 to S912, S915, and S916 illustrated in FIG. 9A are omitted.

In S2101, the plural skeleton obtaining unit 2001 obtains skeletons for the commercial material types designated by the creation condition designation unit 201. Specifically, the plural skeleton obtaining unit 2001 iterates the processes of S921 to S926 in FIG. 9B for the designated commercial material types. Since a search algorithm will be used, the plural skeleton obtaining unit 2001 obtains all skeletons for the designated commercial material types in advance. In the case of FIGS. 5A and 5B as one example, the plural skeleton obtaining unit 2001 obtains all skeletons for “Postcard” and “Banner”.

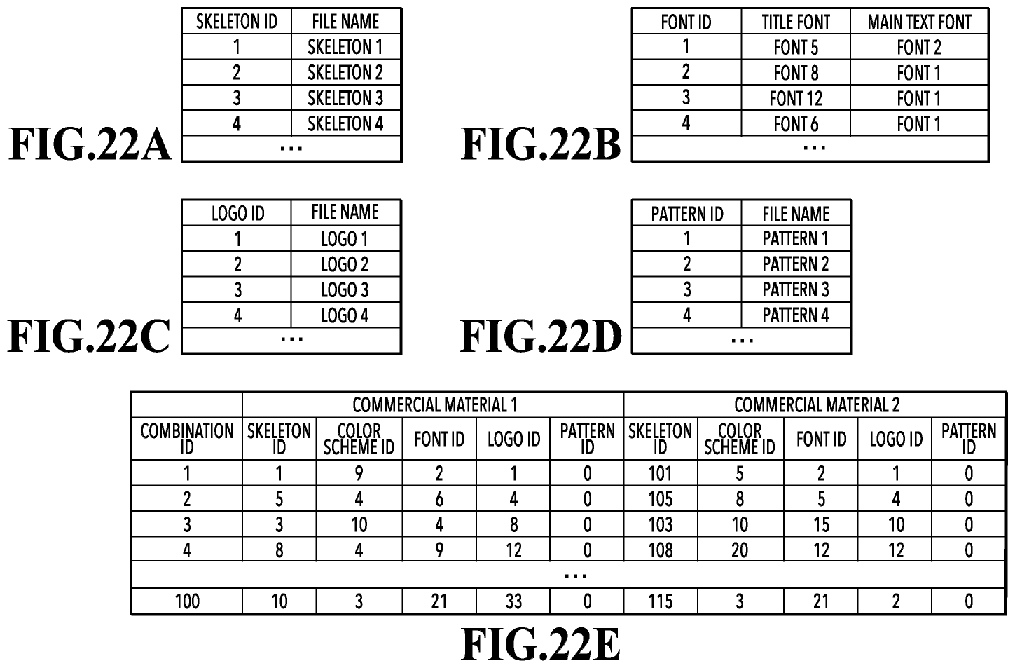

S2102 will be described separately for the operations in the initial execution and for the operations in the second and subsequent loops. First, in the initial execution of S2102, the combination generation unit 2002 obtains tables of skeletons, color schemes, fonts, logos, and patterns to be used in the generation of the commercial materials. The tables used by the combination generation unit 2002 will now be described using FIGS. 4 and 22A to 22E. FIG. 22A illustrates a list of skeletons obtained by the combination generation unit 2002 from the plural skeleton obtaining unit 2001. FIG. 22B illustrates a list of fonts obtained by the combination generation unit 2002 from the design element obtaining unit 214. FIG. 22C illustrates a list of logos obtained by the combination generation unit 2002 from the design element obtaining unit 214. FIG. 22D illustrates a list of patterns obtained by the combination generation unit 2002 from the design element obtaining unit 214. FIG. 4 illustrates a list of color scheme patterns obtained by the combination generation unit 2002 from the color scheme pattern obtaining unit 215. Note that, regardless of which color scheme pattern is selected, the colors in the design of each commercial material to be generated include at least one color at a hue angle that is different from any of the colors in the color scheme included as a design element. In FIGS. 4 and 22A to 22D, only IDs up to 4 are listed, but the number of IDs may be more than four. The present embodiment will be described on the assumption that there are 115 skeleton IDs, 20 color scheme IDs, 21 font IDs, 35 logo IDs, and 10 pattern IDs. The combination generation unit 2002 generates randomly combined and designated commercial materials from the above five tables for the commercial material types. In the present embodiment, the combination generation unit 2002 generates 100 commercial material set combinations. FIG. 22E illustrates a commercial material set combination table generated in the present embodiment. Incidentally, in a case where the design element designation unit 204 has designated a design element, the combination generation unit 2002 sets the same ID for both commercial materials. FIG. 22E illustrates a combination table in a case where a pattern has been designated as a design element. The same pattern ID is set for Commercial Materials 1 and 2. Further, in a case where the design element designation unit 204 has designated a reflection degree, the combination generation unit 2002 determines based on that set value the ratio of combinations to be given the same ID for both Commercial Materials 1 and 2. Specifically, in a case where the reflection degree for the design elements has been designated to be 0.3, 30 combinations among the 100 will be given the same ID while the remaining 70 will be given IDs at random. Subsequently, the combination generation unit 2002 executes the processes of S913, S914, and S2103 on all of the generated combinations.

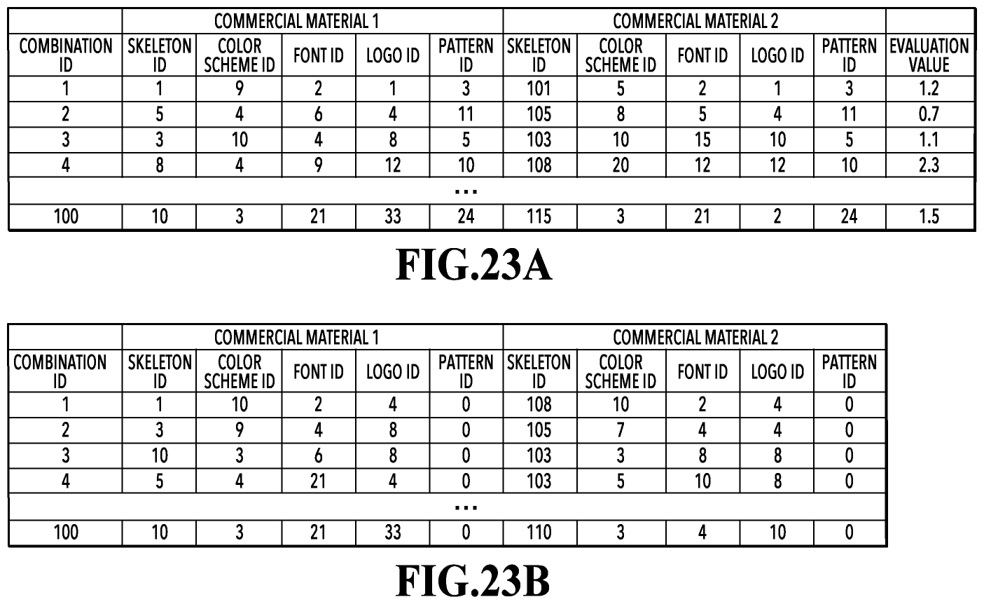

Next, the process of S2102 in the second and subsequent loops will be described. The combination generation unit 2002 calculates evaluation values from the estimated impressions obtained from the impression estimation unit 222, and links them to the commercial material set combination table. The method of calculating the evaluation values is the same as the method of calculating the total impression distance in S917. FIGS. 23A and 23B are diagrams describing the operation in S2102 in the second and subsequent loops. FIG. 23A is a table obtained by linking the above evaluation values to FIG. 22E. The evaluation value column in FIG. 23A lists the evaluation values of the commercial material sets generated by the combinations in the respective rows. The combination generation unit 2002 generates a new combination table from FIG. 23A. FIG. 23B is the newly generated combination table. In the present embodiment, new combinations are generated using tournament selection or uniform crossover in a genetic algorithm. First, the combination generation unit 2002 selects N combinations at random from the table in FIG. 23A. Here assume that N=3, for example. Then, the combination generation unit 2002 selects the top two combinations with the smallest evaluation values (i.e., with the closest target impressions and the highest design similarities) from among the selected combinations. Lastly, the combination generation unit 2002 generates new combinations by randomly swapping the combination elements (skeleton ID, color scheme ID, font ID, logo ID, pattern ID) between the two selected combinations. For example, the combination IDs “1” and “2” in FIG. 23B represent combinations generated from the combinations with the combination IDs “1” and “3” in FIG. 23A, in which the color scheme IDs have been swapped. FIG. 23B is a result of iterating the above procedure to generate 100 new combinations. Note that, regardless of which color scheme patterns are selected in the generated new combinations, the colors in the design of each commercial material to be generated include at least one color at a hue angle that is different from any of the colors in the color scheme included as a design element.

In this way, it is possible to efficiently search for combinations based on the evaluation values of the total impression distances. Note that, in the present embodiment, 100 combinations are generated, but the present embodiment is not limited to this. Also, while tournament selection or uniform crossover is used, the present embodiment is not limited to this. For example, ranking selection, roulette wheel selection, one-point crossover, or another method may also be used. Also, mutation may be incorporated to avoid ending up with local optima. Also, while skeletons (layouts), color scheme patterns, fonts, logos, and patterns are used as commercial material constituent elements to search for, other constituent elements may be used. By increasing the number of constituent elements to search for, a wider variety of posters can be generated, thus broadening the range of expression of impressions.

In S2103, as in S2102, the combination selection unit 2003 calculates the evaluation values of the total impression distances to create the same table as FIG. 23A. The combination selection unit 2003 saves the commercial material sets whose evaluation value of the total impression distance is less than or equal to a predetermined threshold value to the RAM 103. Further, the combination selection unit 2003 determines whether the number of commercial material sets saved in the RAM 103 has reached a predetermined number of combinations. In a case where the combination selection unit 2003 determines that the number of commercial material sets has reached the predetermined number of combinations, the processing proceeds to S917. In a case where the combination selection unit 2003 determines that the number of commercial material sets has not reached the predetermined number of combinations, the processing returns to S2102. That is, the process of S2102 for the second loop described above is executed, and the processes of S2102 to S2103 are iterated until the number of commercial material sets saved in the RAM 103, whose evaluation value of the total impression distance is less than or equal to the threshold value, reaches the predetermined number.

Note that, in the case where the number of saved commercial material sets whose evaluation value is less than or equal to the threshold value reaches or exceeds the predetermined number, the combination selection unit 2003 may compare the evaluation value of each saved commercial material set and finally save only the commercial material set with the smaller evaluation values to the RAM 103. The commercial material set determined to have the larger evaluation value based on the result of the comparison may be deleted from the RAM 103. Note that, in the present embodiment, a genetic algorithm is used to search for combinations of poster constituent elements and design elements, but the search method is not limited to this, and another search method such as a neighbor search method or a tab search method may also be used.

As described above, according to the present embodiment, by searching for combinations of constituent elements and design elements to be used for commercial materials, it is possible to generate commercial material sets that have impressions close to a target impression and have cohesive designs from plural generated commercial materials. This is effective particularly in generating commercial material sets suitable for images and character information input by the user. For example, consider a case where the user wants to generate a commercial material set that has an image exhibiting a dynamic impression but has a subdued overall impression as a commercial material set. In the present embodiment, it is possible to evaluate the impression of each commercial material as a whole and search for combinations of a skeleton, a color scheme pattern, a font, a logo, and a pattern that are close to a target impression and have high design similarity. In this way, it is possible to control the constituent elements of the commercial materials depending on the image to, for example, use skeletons with small image areas or use more subdued fonts or color schemes in order to suppress the impression of the image. Further, it is possible to use skeletons in which the area of the region to arrange the brand information is small in a case where the impression intended by the user and the impression of the brand information are different. According to the present embodiment, it is possible to flexibly find optimal combinations of constituent elements and cohesive design elements for the impression of the commercial material set as a whole. In this way, it is possible to create various variations of commercial materials with cohesive designs by combining plural commercial materials.

### Other Embodiments

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115757, filed Jul. 19, 2024, which is hereby incorporated by reference herein in its entirety.

What is claimed is:

1. An information processing apparatus, comprising one or more processors and/or circuitry which function as:
a designation unit configured to designate a design element to be reflected in one or more commercial materials for which to generate designs, and designate a creation condition for creating the one or more commercial materials; and
a generation unit configured to, based on the design element and the creation condition designated by the designation unit, generate designs of the one or more commercial materials by changing a color scheme included in the design element such that at least one color at a hue angle different from any of colors in the color scheme in the design element.

2. The information processing apparatus according to claim 1, wherein the color at the different hue angle is a color defined by rotating a color wheel by a predetermined angle in a clockwise direction or a counterclockwise direction with respect to one color selected from the design element.

3. The information processing apparatus according to claim 2, wherein the predetermined angle is 30 degrees or 60 degrees.

4. The information processing apparatus according to claim 1, wherein the color at the different hue angle is a complementary color for one color selected from the design element, a contrasting color close to the complementary color, or a similar color close to one selected color.

5. The information processing apparatus according to claim 1, wherein a lightness difference and a saturation difference between the color at the different hue angle and one color selected from the design element are each within a predetermined range.

6. The information processing apparatus according to claim 1, wherein
the design element includes a first design element and a second design element, and
the generation unit changes a color scheme in the first design element and does not change a color scheme in the second design element.

7. The information processing apparatus according to claim 6, wherein the generation unit generates the designs of the one or more commercial materials by changing the color scheme in the first design element in designs of the one or more commercial materials based on a target impression which is an impression required for a commercial material group formed of plural commercial materials including the one or more commercial materials.

8. The information processing apparatus according to claim 7, wherein the designs of a combination of the one or more commercial materials are such that a total impression distance as a sum of distances between the target impression and impressions linked to the designs of the respective commercial materials is less than or equal to a threshold value.

9. The information processing apparatus according to claim 8, wherein the distance between the target impression and the impression linked to the design of each of the generated commercial materials is calculated using one of a Euclidean distance, a Manhattan distance, or cosine similarity.

10. The information processing apparatus according to claim 1, wherein the generation unit generates the designs of a combination of the one or more commercial materials by using a genetic algorithm.

11. The information processing apparatus according to claim 10, wherein the genetic algorithm is one of tournament selection, uniform crossover, ranking selection, roulette wheel selection, or one-point crossover.

12. The information processing apparatus according to claim 1, wherein the one or more processors and/or circuitry further function as a display control unit configured to display a user interface screen (UI screen) for designating the design element and the creation condition on a display device.

13. The information processing apparatus according to claim 12, wherein the display control unit displays a preview of the designs of the one or more commercial materials generated by the generation unit on the UI screen.

14. The information processing apparatus according to claim 1, wherein
the design element includes a color scheme, a pattern, a logo, and a font, and
the creation condition includes types of the commercial materials to be created, a purpose of use of the commercial materials, the number of key colors to be added to the commercial materials, and information on whether to change a background.

15. A method of controlling an information processing apparatus, comprising:
designating a design element to be reflected in one or more commercial materials for which to generate designs, and designating a creation condition for creating the one or more commercial materials; and
based on the design element and the creation condition designated in the designating, generating designs of the one or more commercial materials by changing a color scheme included in the design element such that at least one color at a hue angle different from any of colors in the color scheme in the design element.

16. A non-transitory computer readable storage medium storing a program which causes a computer to execute a method of controlling an information processing apparatus, the method comprising:
designating a design element to be reflected in one or more commercial materials for which to generate designs, and designating a creation condition for creating the one or more commercial materials; and
based on the design element and the creation condition designated in the designating, generating designs of the one or more commercial materials by changing a color scheme included in the design element such that at least one color at a hue angle different from any of colors in the color scheme in the design element.
